(19) United States
(12) Patent Application Publication
(10) Pub. No.: US 2009/0109841 A1
(43) Pub. Date: Apr. 30, 2009

(54) Layer-2 Redundancy Protocol Interconnection Device

(76) Inventors: Shinji Nozaki, Kawasaki (JP); Hiroto Sakurai, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/178,808

(22) Filed: Jul. 24, 2008

(30) Foreign Application Priority Data
Oct. 24, 2007 (JP) 2007-275901

(51) Int. Cl. H04L 12/24

(52) U.S. Cl. 370/218

(57) ABSTRACT

Interconnection devices and interconnect a network running a redundancy protocol and another network running a redundancy protocol. The interconnection devices controls the redundancy protocol of a lower level network via virtual ports and by a virtual link, to redundancy-connect the lower level network to a higher level network. When a communication route of the lower level network is changed, MAC address learning results of the higher level network are cleared to perform switching of communication routes at high speed.

### BACKGROUND OF THE INVENTION

1. Field of the Invention

The present invention relates to techniques of allowing a flexible network to be configured, by realizing simultaneous adoption of a plurality of redundancy protocols on one network, in order to adopt a redundancy protocol suitable for a network architecture of a network using a redundancy protocol providing redundancy of a communication route. The present invention relates also to techniques allowing localization of influence of switching of a communication route upon communications and devices to reduce a load on a network adopting a redundancy protocol, and realizing high speed switching of a communication route.

2. Description of the Related Art

When a network is configured, a redundancy protocol is used in some cases in order to realize redundancy of communication routes. There are various protocols for redundancy of communication routes: protocols employing a network architecture such as a mesh architecture and a ring architecture; and protocols independent from the architecture. For redundancy of communication routes, there are provided devices and lines used as a communication route in a normal state and devices and lines used as a substitute communication route when a failure occurs on the normal communication route, and a redundancy protocol detects a failure and controls switching to the substitute communication route to thereby preserve communication reliability.

A layer-2 redundancy protocol makes portions of devices and lines used as a substitute communication route in the normal state and prepared in a network architecture enter a logically incommunicable state (hereinafter, a point in the logically blocking state is called a blocking point), to thereby prevent a network loop. A blocking point is set to the substitute route in the normal state, and when a failure is detected in the normal communication route, the blocking point is changed to a communicable forwarding state, and this substitute route is used.

Each redundancy protocol is specific to the mesh architecture, ring architecture or the like, and the protocol to be used is determined by its use application. For example, in some cases, a protocol depending upon the mesh architecture or not depending upon the architecture is adopted because of reuse of an already existing network or long term actual use, or in other cases, a protocol depending upon the ring architecture is used because of different wiring amounts of communication routes or influence of a device upon a CPU load.

In configuring a layer-2 network, it is easy to use one redundancy protocol for the whole network, and the redundancy protocol is selected in accordance with the scale and architecture of the network. On the other hand, in configuring a large scale layer-2 network, there is a case wherein a proper redundancy protocol becomes different in each network segment of the network architecture. A large scale network is, for example, a network dealing with communications in the whole building and a wide area network for interconnecting area sites. A desired redundancy protocol becomes different between network architectures (hereinafter called an edge network) for interconnection of intra-floors and of area sites and for a network architecture (hereinafter called a core network) for interconnection between inter-floors and between area sites. For example, since there are a number of edge networks, the reconfiguration of all networks is difficult so that reuse of already existing networks is desired, whereas the core network is desired to reduce the wiring amount of communication routes because of a distance issue. It is therefore desired that a proper protocol can be selected in accordance with each network segment of the network architecture, without using only the method of configuring the whole network by using one redundancy protocol.

Different administrators manage the edge networks and core network in some cases, and the networks are configured in accordance with the running policies of the administrators. In such cases, even if the whole network is configured by using one redundancy protocol, it is desired in some cases to separately and independently run each network segment of the network architecture.

As a method of using a different protocol for each network segment of the architecture of the edge networks and core network, there has been proposed a method of relaying a control packet of a redundancy protocol. A device in the edge network operates the redundancy protocol and transmits a control packet of the protocol to the core network. Upon reception of the control packet from the edge network, the core network does not execute a protocol process but only relays the control packet. The relayed control packet arrives at another device of the edge network via the core network, and the device executes the protocol process. With this method, the edge networks establish a plurality of communication routes to the core network, and execute switching of communication routes by using the redundancy protocol.

With reference to FIG. 1, description will be made on a conventional method of relaying a control packet of a redundancy protocol. Devices 101 to 106 constitute a core network, and a redundancy protocol closed in these devices operates. A device 111 constitutes an edge network, and a redundancy protocol operates independently from the core network. The device 111 transmits a control packet 121 of the redundancy protocol, and each device in the core network will not receive the control packet but only relays the control packet. The control packet 121 arrives again at the edge network via the core network. In the example shown in FIG. 1, the device 111 receives the control packet at its other port. By making the devices in the core network relay the control packet in this manner, the device in the edge network operates as if it is logically connected via the core network.

An L2 protocol frame transparency function, described in AX7800S/AX5400S Software Manual Applications Guide, Vol. 1, Ver. 10.2 compatible, ALAXALA networks Corporation, June 2006, pp. 190 and 191, is a function of relaying a bridge protocol data unit (BPDU) which is a control packet of a spanning tree protocol, one of layer-2 redundancy protocols. The L2 protocol frame transparency function has a function of relaying BPDU which is not relayed in the normal state. In the example shown in FIG. 1, if this function is adopted by the core network when the edge network uses the spanning tree protocol, the spanning tree protocol can be operated in the edge network.

The spanning tree protocol described in IEEE802.1D makes devices constituting a network routinely exchange a control packet called BPDU in order to shut off a loop structure. BPDU mounts a plurality of pieces of protocol information for determining the operation of a protocol. In accordance with this information, each device received BPDU sets a blocking point to a port at a position to which a substitute route belongs, to thereby logically prevent a network loop. When a failure of the normal route or a change in the network architecture occurs, the spanning tree protocol propagates BPDU over the whole network, and all devices clear protocol processes and MAC address learning results to thereafter switch the communication route to a substitute route.

The layer-2 redundancy protocol is required to update the results of MAC address learning when a change in the communication route occurs. When a change in the communication route is detected, the redundancy protocol clears the MAC address learning results to realize high speed switching to a substitute route. However, according to the above-described conventional techniques, if redundancy programs operate independently as in the case of the above-described edge networks and core network, even if a change in the communication route occurs in one redundancy program, this change is not notified to the other redundancy programs so that the MAC address learning results are not cleared and updated. There arises a problem of a delay in communication recovery.

With reference to the architecture shown in FIG. 1, description will be made on a case wherein communication recovery is delayed because MAC address learning results are not cleared. The devices 101 to 106 constituting the core network and the device 111 constituting the edge network operate the redundancy protocol independently. It is assumed herein that the device 111 uses a line between the devices 111 and 104 as a communication route in the normal state, and that the line between the devices 111 and 106 is in a logically blocking state as a substitute communication route. It is assumed that the redundancy program of the core network makes lines between the devices 102 and 105 and between the devices 104 and 105 be in a logically blocking state, and that for example, a communication route from the device 102 to the device 111 is established via devices 102, 101, 104 and 111. In this case, the MAC address learning result of the device 102 indicates a direction toward the device 101. When a failure occurs in a line between the devices 111 and 104, the redundancy protocol at the edge network, i.e., at the device 111 changes the substitute line between the devices 111 and 106 from the blocking state to a forwarding state to start using this line. However, since the redundancy protocol of the core network is independent and a change in the communication route of the edge network will not be notified to the devices 101 to 106, update of the MAC address learning results by clearing is not executed in the core network. Therefore, the MAC address learning result of, e.g., the device 102 indicates still the direction toward the device 101. With this operation, the MAC address learning results are therefore not coincident with the actual network, posing a problem that communications cannot be recovered although the device 111 switched the communication route by its redundancy protocol. Communication recovery stands by until the MAC address learning result of the device 102 is deleted by time-out. It takes therefore a long time until communication recovery is established.

Many recent layer-2 redundancy protocols change the communication route to the substitute route at high speed, by directly interconnecting the devices to directly detect a failure of each line. In contrast, the above-described conventional techniques adopt an approach to relaying a control packet via the core network, and waiting for time-out of a timer regarding the control packet because a failure of each line cannot be detected due to non-direct interconnections. There arises therefore a problem of an abnormally longer time taken for switching the communication route. In the example shown in FIG. 1, if a failure occurs in the devices 102 and 105 and the communication routes of the core network are shut off, the control packet of the device 111 constituting the edge network is unable to reach. Since this failure occurs at locations which the device 111 cannot detect directly, failure detection waits for time-out of the control packet.

According to the above-described conventional techniques, if a failure occurs in two or more lines in the core network at the same time, the control packet of the redundancy protocol of the edge network becomes unable to arrive at the core network so that the communication route is switched after the time-out. As a result, for connection from the edge network to the core network, there may exist a plurality of communication routes arrivable to the core network. In the example shown in FIG. 1, the communication routes from the device 111 to the devices 104 and 106 enter the forwarding state and become both available. When the core network recovers from two or more failures, the above-described conventional techniques recover first the communications of the core network, thereafter arrivability of the control packet of the redundancy protocol of the edge network recovers, and the edge network changes the communication routes to the normal route. In this case, during the period from when the core network is recovered to when the communication routes of the edge network are changed to the normal communication routes, the edge network continues to have a plurality of communication routes to the recovered core network, resulting in a problem that a loop of the whole network occurs temporarily.

A method of readily avoiding the problem that a line failure cannot be detected directly in the relay approach of the above-described techniques may be a method by which the device in the core network for connecting the edge network operates the redundancy protocol of the core network and at the same time operates the redundancy protocol of the edge network.

With reference to FIG. 2, description will be made on the configuration of making the device in the core network for connecting the edge network operate the redundancy protocol of the edge network at the same time. Devices 201, 202, 203 and 206 constitute a core network, and devices 204 and 205 constitute the core network and connect the core network to an edge network. The devices 204 and 205 operate the redundancy protocol of the core network, at the same time operate the redundancy protocol of the edge network, and transmit/receive control packets 221, 222 and 223 of the redundancy protocol of the edge network including a device 211.

In the method by which the devices in the core network for connecting the edge network operate the redundancy protocol of the edge network at the same time, in order to solve the problem that a line failure cannot be detected directly in the relay approach of the above-described techniques, the devices 204 and 205 are required to be connected directly, resulting in a problem that the network architecture has some restrictions so that a flexible network architecture is impossible.

There is another problem that a large loop riding over the control range of a plurality of redundancy protocols cannot be prevented if positions of blocking points for preventing a network loop in the redundancy protocols of the core and edge networks fall on the same line. In the example shown in FIG. 2, the redundancy protocol of the core network sets a blocking point to the line 231, and both the redundancy protocols of the core and edge networks set a blocking point to the line 241. In such a case although each redundancy protocol of the core and edge networks prevents a network loop in each control range of the redundancy protocol, a large network loop is formed such as a communication route 251. In addition, even if the positions of the blocking points of the redundancy protocols of the core and edge networks do not fall on the same line, if the blocking point of the redundancy protocol of the edge network is set to a line of the core network, this blocking point falls on a normal communication route of the core network, resulting in a problem of a loss of communication arrivability of the core network.

Another issue to be solved by the present invention pertains to that all devices in the whole network are required to clear protocol processes and MAC address learning results, if a failure or a change in the network architecture occurs, as indicated in IEEE802.1D. Since a failure or a change in the architecture propagates to the whole network, there arises a problem that a failure in a terminal device of a large scale network influences another remote terminal device irrelevant in terms of the architecture so that a load of each device in the whole network is increased, and a problem that since a change in the architecture such as addition of a device to the network influences the whole network, the architecture cannot be changed easily.

### SUMMARY OF THE INVENTION

The present invention therefore settles the above-described issues, provides interconnection for a plurality of redundancy protocols in networks, prevents a large loop in the whole network, preserves communication arrivability in each architecture network segment under control of each redundancy protocol, enables update of MAC address learning results, and realizes high speed switching of a communication route without network architecture restrictions regarding provision of interconnection and without dependency upon time-out of a control packet, to thereby realize flexible network design adopting a redundancy protocol suitable for each architecture network segment. Further, when a network is configured by using one redundancy protocol, protocol processes associated with switching of a communication route are localized to reduce a load associated with a failure and an architecture change and facilitate the architecture change.

According to the present invention, a network is partitioned in a hierarchical structure, and an independent redundancy protocol operates at each hierarchical level. A device interconnecting a partitioned network (hereinafter called a higher level network) operating a protocol at a higher hierarchical level (hereinafter called a higher level protocol) and a partitioned network (hereinafter called a lower level network) operating a protocol at a lower hierarchical level (hereinafter called a lower level protocol) is called a device interconnecting both the protocols (hereinafter called an interconnection device). The interconnection device has ports for connection to the lower level network and lower level protocol (hereinafter called a lower level port).

In the following description, a device belonging to the higher level network is intended to mean the device belonging only to the higher level ports of the interconnection device and the higher level network, and if a much higher level network higher than the higher level network exists in the network hierarchical structure, the lower ports (ports connected to the higher level network) of the interconnection device for interconnecting the higher level network and much higher network. Similarly, a device belonging to the lower level network is intended to mean the device belonging only to the lower level ports of the interconnection device and the lower level network, and if a much lower level network lower than the lower level network exists in the network hierarchical structure, the higher ports (ports connected to the lower level network) of the interconnection device for interconnecting the lower level network and much lower level network.

In partitioning the hierarchical structure of a network, the network may be partitioned into two subnetworks, one being a higher level network and the other being a lower level network, or a plurality of lower level networks may be connected to one higher level network. Further, a hierarchical structure of three or more layers may be used such as a lower level network, a higher level network and a much higher level network.

With reference to FIG. 3, description will be made on a structure that a network is partitioned into a hierarchical structure. Networks 301 to 307 are in the control range of redundancy protocols. Interconnection devices 311 and 312 interconnect a redundancy protocol 1 as a higher level protocol operating on the hierarchical higher level network 301 and a redundancy protocol 2 as a lower level protocol operating on the hierarchical lower level network 302. The redundancy protocol 2 operating on the network 302 is a higher level protocol as viewed from interconnection devices 315 and 316, and 317 and 318, and a lower level protocol of the redundancy protocol 2 is a redundancy protocol 4 operating on the network 304 and a redundancy protocol 5 operating on the network 305. Similarly, as viewed from interconnection devices 313 and 314, the higher level protocol is the redundancy protocol 1 operating on the network 301, and the lower level protocol is the redundancy protocol 3 operating on the network 303. The redundancy protocol 3 operating on the network 303 is a higher level protocol as viewed from interconnection devices 319 and 320, and 321 and 322, and a lower level protocol of the redundancy protocol 3 is a redundancy protocol 6 operating on the network 306 and a redundancy protocol 7 operating on the network 307.

In the interconnection device 311, a higher level port 331 is a port for connection to the higher level network 301, and a lower level port 332 is a port for connection to the lower level network 302. The number of higher and lower level ports may be set as desired. Also in the other interconnection devices, the higher level port is a port for connection to the higher level network, and the lower level port is a port for connection to the lower level network.

Description will be made on the operation of the higher level protocol at the interconnection device. The higher level protocol at the interconnection device operates by using only the higher level port as a control target. The higher level port transmits/receives the control packet of the higher level protocol, and controls the blocking state of the higher level port representative of a logically incommunicable state, and the forwarding state of the higher level port representative of a communicable state, to thereby preserve redundancy of the communication route of the higher level network and prevent a network loop. In the interconnection device, the higher level protocol and ports will not pertain to the lower level protocol and ports, but operate independently.

Description will be made on the connection structure from the lower level network to the higher level network. The lower level network is connected to the higher level network via a plurality of interconnection devices in order to preserve redundancy of connection to the network operating the higher level protocol. With this connection, if a failure of an architecture change occurs in the lower level port and network, a communication route to the high level network is preserved via another interconnection device.

Description will be made on the operation of the lower level protocol at the lower level port of the interconnection device. The lower level protocol operates by using the lower level port at the interconnection device as a control target in the manner similar to the conventional techniques. The lower level port transmits/receives the control packet of the lower level protocol, and controls the blocking state of the lower level port representative of a logically incommunicable state and the forwarding state of the lower level port representative of a communicable state.

Description will be made on the structure of connection to the higher level network by the lower level protocol at interconnection devices. The lower level protocol operates at the interconnection devices by assuming that the higher level network is a single virtual line and that the interconnection devices are connected by a single virtual line (hereinafter called a virtual link). Each interconnection device has a virtual port (hereinafter called a virtual port) concentrating all higher level ports and corresponding to connection to the virtual link. The lower level protocol at the interconnection device operates by using the lower ports and virtual port as a control target. A control packet of the lower level protocol to be transmitted/received at the virtual port is transmitted/received via all higher ports corresponding to the virtual port. Only one communication route between the interconnection devices is established by the higher level protocol for the higher level network used as the communication route of the virtual link. The control packet transmitted from the lower level protocol to all higher level ports via the virtual port arrives at another interconnection device. The control packet of the lower level protocol is transmitted/received at the virtual port and at all lower level ports of the interconnection device to control the blocking state representative of a logically incommunicable state and the forwarding state representative of a communicable state, respectively of the virtual port and lower level ports.

With reference to FIG. 4, description will be made on connection of a lower level protocol at interconnection devices by virtual ports and a virtual link. Interconnection devices 411 and 412 are devices for interconnecting redundancy protocols of a higher level network 401 and a lower level network 402. The redundancy protocol operating on the higher level network 401 operates higher level ports 441, 442 and 443 and higher level ports 444, 445 and 446 of the interconnection devices 411 and 412 to control preservation of the communication routes and redundancy of the higher level network and prevention of a network loop. The interconnection device 411 has a virtual port 431 corresponding to all higher level ports 441, 442 and 443, and the lower level protocol operates at the virtual port 431 and lower level ports 451, 452 and 453. The interconnection device 412 has a virtual port 432 corresponding to all higher level ports 444, 445 and 446, and the lower level protocol operates at the virtual port 432 and lower level ports 454, 455 and 456. A device 461 belonging to the lower level network, on which the lower level protocol operates, is connected to the lower ports of the interconnection devices 411 and 412, and the lower level protocol operates by using this connection and a virtual link 421 connected by the virtual ports 431 and 432 of the devices 411 and 412.

Description will be made on how the lower level protocol handles the virtual ports at the interconnection devices. The lower level protocol sets the states of virtual ports of the interconnection devices always to an up-state, and operates to set a logical state representative of a communicable/incommunicable state to the forwarding state. In order to set the virtual port to the forwarding state, the lower level protocol regards the virtual port as having a highest priority degree of communication route selection. The virtual link preserves communication routes and redundancy and prevents a network loop, in accordance with the redundancy protocol of the higher level network. Therefore, reliability of communications over the virtual link can be preserved, and the control packet of the lower level protocol to be transmitted and received via the virtual link and higher level network has reliable arrivability.

Description will be made on the virtual link connecting interconnection devices connected to the same lower level network. The virtual link is a link to be used by the interconnection devices to transmit/receive a control packet of the lower level protocol via the higher level network. The control packet of the lower level protocol to be transmitted from the interconnection device to the virtual link via the virtual port is transmitted to all higher level ports corresponding to the virtual port. However, the control packet is not transmitted to the higher level port in the logically blocking state made by the higher level protocol. Each device and port belonging to the higher level network receive the control packet only from the port in the forwarding state, in accordance with settings of blocking points of the higher level protocol, and relays the control packet only to the port in the forwarding state. Another interconnection device connected to the same lower level network receives the control packet only from the port in the forwarding state, in accordance with settings of blocking points of the higher level protocol, to use the control packet for controlling the lower level protocol, and relays the control packet only to a higher level port in the forwarding state made by the higher level protocol. With these operations of transmission, reception and relay, the control packet of the lower level protocol sent to the virtual link via the virtual port reaches without duplication all interconnection devices belonging to the same lower level network via the higher level network with preserved redundancy and reliability.

If two interconnection devices are connected to the same lower level network, the virtual link is logically equivalent to a direct connection state between the two interconnection devices. In this case, after the interconnection device receives a control packet of the lower level protocol at the higher level ports, the interconnection device only receives the control packet and is not necessary to relay it to other higher level ports. Whether the control packet received at the higher level port is relayed or not may be selectively determined. This relay selection may use a selection method based on device settings, a method of not relaying if the interconnection devices have only one virtual port or relaying if the interconnection devices have two or more virtual ports, or other methods.

With reference to FIG. 5, description will be made on transmission/reception of a control packet of the lower level protocol via the virtual link. Interconnection devices 511 and 512 are connected to a higher level network 501 and a lower level network 502. The interconnection devices 511 and 512 have virtual ports 531 and 532 and higher level ports 541 to 543 and 544 to 546, and are constituted of a virtual link 521. The lower level protocol at the interconnection device 511 transmits a control packet to the virtual port 531, and control packets 551 to 553 are transmitted from the higher level ports 541 to 543 corresponding to the virtual port 531. Of the control packets transmitted from the interconnection device 511, the control packets 551 and 553 reach blocking points and are discarded (561 and 562), whereas the control packet 552 reaches the interconnection device 512, in accordance with the settings of blocking points by the higher level protocol. The lower level protocol at the interconnection device 512 executes a reception process for the arrived control packet 552, and at the same time relays the control packet 552 to a higher level port other than the higher level port received the control packet. Similarly, the interconnection device 512 transmits the control packets 554 to 556, and of these control packets, the control packets 554 and 556 reach blocking points and are discarded (563 and 564), whereas the control packet 555 reaches the interconnection device 511, in accordance with the settings of blocking points by the higher level protocol. The lower level protocol at the interconnection device 511 executes a reception process for the arrived control packet 555, and at the same time relays the control packet 555 to a higher level port other than the higher level port received the control packet. If the control packets 551, 553, 554 and 556 reach the interconnection device connected to the same lower level network before they reach blocking points of the higher level protocol and are discarded, the lower level protocol of the interconnection device executes the reception process and at the same time relays the control packet.

Description will be made on the architecture in which three or more interconnection devices are connected between the lower level network and higher level network and a lower level protocol is used requiring the direct connection structure of lines among the devices in one-to-one correspondence. The lower level protocol at the interconnection device prepares virtual links for connection to other interconnection devices via a route of the higher level network, the virtual links corresponding in number to the number of other interconnection devices. The interconnection device has virtual ports each connecting the corresponding virtual link and collecting all corresponding higher level ports, the virtual ports corresponding in number to the number of other interconnection devices and connected to a plurality of other interconnection devices via the virtual links in one-to-one correspondence. The lower level protocol at the interconnection devices operate by using the lower level ports and a plurality of virtual ports as its control target.

With reference to FIG. 6, description will be made on the virtual port and virtual link in the architecture in which three or more interconnection devices are connected between the lower level network and higher level network and a lower level protocol is used requiring the direct connection structure of lines among the devices in one-to-one correspondence. Interconnection devices 611 to 613 are devices for interconnecting a higher level network 601 and a lower level network 602. The lower protocol at respective interconnection devices provides virtual ports 631 and 632, 633 and 634 and 635 and 636 for one-to-one correspondence connection to respective interconnection devices. The virtual link 621 connects the interconnection devices 611 and 613 by the virtual ports 631 and 636 in one-to-one correspondence, the virtual link 622 connects the interconnection devices 611 and 612 by the virtual ports 632 and 633 in one-to-one correspondence, and the virtual link 623 connects the interconnection devices 612 and 613 be the virtual ports 634 and 635 in one-to-one correspondence.

Description will be made on the architecture in which three or more interconnection devices are connected between the lower level network and higher level network and a lower level protocol is used requiring the direct connection structure of lines among the devices in one-to-one correspondence. The virtual port state of the interconnection device is set always to an up-state. The lower level protocol operates in such a manner that all virtual ports of all interconnection devices are processed as a port having a higher priority degree of communication route selection than that of the lower level ports. By connecting the virtual ports in one-to-one correspondence and processing the virtual port as a port having a higher priority degree, a pseudo network loop structure (namely without forming a network loop over lower ports being blocked) between virtual links positioned in the higher level network is structured as an arrivable communication route without involvement of the single lower level network side, by communication route selection by the protocol among the virtual ports having a higher priority order than that of the lower level ports. Settings of block pints will not be made shutting off the loop structure on the lower level network side by the virtual links. Namely, a communication route among the interconnection devices by the lower level protocol becomes a route via the virtual links in the higher level network and will not become a route via the lower level network. This is perfectly coincident with that the higher level protocol of the higher level network preserves only one communication route via the higher level ports and higher level network. Logical states of the virtual ports are set either to the forwarding state or to the blocking state, in accordance with the communication route selection. The blocking state of the virtual port is a pseudo state under control of the lower level protocol, and is irrelevant to actual communications.

The interconnection device having the virtual ports and virtual links described heretofore transmits, receives and relays a data packet using the device as a communication route, in accordance with the logical forwarding and blocking states by the lower level protocol, at the lower level ports, and in accordance with the logical forwarding and blocking states by the higher level protocol, at the higher level ports.

Description will be made on a method of discriminating between a control packet of the higher level protocol to be transmitted/received at the higher level ports of the interconnection device and a control packet of the lower level protocol to be transmitted/received at the higher level ports via the virtual port. If the higher level protocol and lower level protocol are different and if another lower level network using the same lower level protocol is not connected to the higher level network, then the control packets are different and can be discriminated in accordance with the specifications of the protocols.

In another method of discriminating between a control packet of the higher level protocol to be transmitted/received at the higher level ports of the interconnection device and a control packet of the lower level protocol to be transmitted/received at the higher level ports via the virtual port, a virtual LAN (VLAN) (hereinafter called a lower level protocol dedicated VLAN) is set which transmits/receives a control packet of the lower level protocol and includes the higher level ports of interconnection devices and devices and ports belonging to the higher level network. When the control packet of the lower level protocol is to be transmitted to the higher level ports corresponding to the virtual port, the interconnection device transmits the control packet to the lower level protocol dedicated VLAN, and the control packet reached from the lower level protocol dedicated VLAN is received via the virtual port and processed by the lower level protocol. Devices and ports belonging to the higher level network other than the interconnection device do not discriminate the packet of the lower level protocol dedicated VLAN but relay the packet without identifying the content of the packet.

In still another method of discriminating between a control packet of the higher level protocol to be transmitted/received at the higher level ports of the interconnection device and a control packet of the lower level protocol to be transmitted/received at the higher level ports via the virtual port, when the control packet of the lower level protocol is to be transmitted to the higher level ports corresponding to the virtual port, the interconnection device stores a number for identifying the lower level network (hereinafter called a lower level network number) in the control packet. Devices belonging to the higher level network and the higher level ports of the interconnection device discriminate the control packet of the lower level protocol, in accordance with the lower level network number stored in the received packet.

Description will be made on a method of discriminating between a control packet of the higher level protocol to be transmitted/received at the higher level ports of the interconnection device and a control packet of the lower level protocol to be transmitted/received at the higher level ports via the virtual port, in the case wherein three or more interconnection devices are connected between a lower level network and a higher level network and a lower level protocol is used requiring the direct connection structure of lines among the devices in one-to-one correspondence. In one method, a dedicated VLAN (hereinafter called a virtual link dedicated VLAN) is provided for each virtual link which includes the higher level ports of the interconnection device and devices and ports belonging to the higher level network, and the interconnection device transmits/receives via the virtual link dedicated VLAN the control packet of the lower level protocol, among virtual ports connected in one-to-one correspondence. In another method, a number (hereinafter called a virtual link number) for identifying the virtual link is stored in the control packet of the lower level protocol. Devices belonging to the higher level network and the higher level ports of the interconnection device discriminate the virtual port of the received packet, in accordance the virtual link number stored in the received packet.

Description will be made on a method of connecting a plurality of lower level networks to one higher level network. If different lower level networks are connected to one higher level network, each interconnection device of one lower level network has a virtual link irrelevant to another lower level network, and the control packet of the lower level protocol is processed via a corresponding virtual link. Devices and ports belonging to the higher level network and the higher level ports of the interconnection device discriminate the lower level network of the control packet, by setting the above-described lower level protocol dedicated VLAN to each lower level network or storing the above-described lower level network number in the control packet.

With reference to FIG. 7, description will be made on a method of storing the lower level network number and virtual link number in the control packet of the lower level protocol when the control panel is transmitted/received at the virtual link. One method is illustrated at 701 and 702. An encapsulating header 701 for the virtual link is added to the head of the control packet of the lower level protocol, and the control packet 702 of the lower level protocol including a packet header is stored after the encapsulating header. The lower level network number and virtual link number are stored in any one of a transmission destination address, transmission source address and another field of the encapsulating header 701, and the control packet of the lower level is remained being stored after the encapsulating header.

In another method of storing the lower level network number and virtual link number in the control packet of the lower level protocol when the control packet is to be transmitted/received at the virtual link, the lower level network number and virtual link number are stored in a transmission source address field 704 of the packet header contained in the control packet 703 of the lower level protocol.

In still another method of storing the lower level network number and virtual link number in the control packet of the lower level protocol when the control packet is to be transmitted/received at the virtual link, a control packet 705 of the lower level protocol itself is placed at the head of the packet, and the lower level network number and virtual link number 706 are stored after the control packet.

The method of storing the lower level network number and virtual link number in the control packet of the lower level protocol when the control packet is to be transmitted/received may be other methods with respect to the field of the packet where the lower level network number and virtual link number are stored. The lower level network number and virtual link number may be stored in an empty field or a field storing a meaning less value of the control packet of the lower level protocol.

Description will be made on a method of updating MAC address learning results of the higher level network when a communication route change occurs in the lower level protocol. When a communication route change occurs in the lower level protocol due to a failure or a configuration change, the interconnection device detected a communication route change transmits a packet (hereinafter called a MAC address learning clear packet) for clearing the MAC address learning results in the higher level network, to the higher level network. The MAC address learning clear packet is transmitted to all higher level ports of each interconnection device. However, the MAC address learning clear packet is not transmitted to the higher level port entered the logically blocking state by the higher level protocol.

Upon reception of the MAC address learning clear packet from the higher level port entered in the forwarding state by the higher level protocol, a device and ports belonging to the higher level network clear the MAC address learning results of the device, and the MAC address learning clear packet is relayed to another higher level port entered in the forwarding state by the higher level protocol.

Upon reception of the MAC address learning clear packet from the higher level port entered in the forwarding state by the higher level protocol, the other interconnection device received the MAC address learning clear packet clears the MAC address learning results at the higher level ports of the interconnection device, and relays the MAC address learning clear packet to all higher level ports entered in the forwarding state by the higher level protocol. The MAC address learning clear packet is processed by all interconnection devices connected to the higher level network. Even for the MAC address learning clear packet transmitted from an interconnection device of a different lower level network, the interconnection device connected to the same higher level network executes clearing of the MAC address learning results and relaying of the MAC address learning clear packet.

Description will be made on another method of processing the virtual port by the lower level protocol at the interconnection device. The virtual link via a route of the higher level network is a line whose reliability is ensured by the higher level protocol. However, if two or more failures occur in the higher level ports or devices and ports belonging to the higher level network, communication arrivability may be lost including the substitute route. In this case, communication arrivability of the virtual link is lost. In order to detect an incommunicable state, the interconnection device transmits a packet (hereinafter called a health check packet) for confirming communication arrivability of the higher level network to the virtual link at a periodical interval (hereinafter called a health check packet transmission interval). The health check packet is transmitted to all higher level ports corresponding to the virtual port. However, the health check packet will not be transmitted to the higher level port entered in the logical blocking state by the higher level protocol. Upon reception of the health check packet, the devices and ports belonging to the higher level network relay the packet only to the port in the forwarding state in accordance with the settings of blocking points by the higher level protocol. Upon arrival of the health check packet, another interconnection device connected to the same lower level network receives the packet only from the port in the forwarding state, and relays the packet only to the higher level port entered in the forwarding state by the higher level protocol, in accordance with the settings of blocking points by the higher level protocol. With these operations of transmission and relay, the health check packet sent to the virtual link via the virtual port arrives at all interconnection devices belonging to the same lower level network via the higher level network with redundancy and ensured reliability, without any duplication. The interconnection device received the health check packet confirms communication arrivability of the virtual link. All interconnection devices connected to the same lower level protocol transmit the health check packet. So long as the communication arrivability of the virtual link is confirmed, the interconnection device operates by setting the up-state to the virtual port. If the interconnection device does not receive the health check packet during a predetermined period (hereinafter called a health check packet time-out time) due to two or more failures in the higher level network, the interconnection device detects a failure in the virtual link and changes the state of the virtual port to the down-state. A change to the down-state of the virtual port is notified to the lower level protocol which in turn switches a communication route. Even after the virtual port is changed to the down-state, the interconnection device tries periodical transmission/reception of the health check packet, and changes the state of the virtual port to the up-state when communication arrivability is again confirmed due to recovery from two or more failures of the higher level network. Similar to a change to the down-state, a change to the up-state is notified to the lower level protocol which in turn switches to a normal communication route to return to the normal state. The health check packet time-out time may be irrelevant to the timer to be used for control by the lower level protocol.

When the higher level network recovers from two or more failures, the higher level protocol may first recover communications of only the control packet of the lower level protocol via the virtual link, and after confirming that the lower level protocol switches to the normal route, may recover data communications of the higher level network.

Description will be made on a method of detecting recovery from two or more failures of the higher level network. In the state that the higher level protocol changes a communication route in the state that the virtual port is in the down-state, the interconnection device first changes a communication route for only the control packet of the lower level protocol, health check packet and MAC address learning clear packet, and stands by during the health check time-out time before the communication route is actually changed, for other data packets. If a health check packet is received from another interconnection device within the health check time-out time, the state of the virtual port is changed to the up-state, and a process for the lower level protocol is executed before a process for the higher level protocol. If a health check packet is not received from another interconnection device within the health check time-out time, the state of the virtual port is changed to the down-state, and a process for the higher level protocol is executed.

Switching to the normal communication route by the lower level protocol may be confirmed by any method capable of indicating completion of communication route switching by the lower level protocol. For example, this switching may be confirmed by a method of waiting during a predetermined time counted with a timer having a short time necessary for high speed switching of a communication route by the lower level protocol, by a method of waiting for reception of a control packet indicating completion of switching by the lower level protocol or other methods.

If an interconnection device having a plurality of virtual ports monitors a plurality of virtual links in the higher level network with a health check packet, virtual link numbers are stored in the health check packet.

One interconnection device of the present invention may be connected to a plurality of lower level networks. In this case, the interconnection device has virtual ports and corresponding virtual links corresponding in number to the number of lower level networks, and one lower level network may have a plurality of virtual ports. Also in this architecture, the operations similar to those described above are performed for the operation of the higher level protocol, the operation of the lower level protocol for each lower level network, update of MAC address learning, and the like.

According to the interconnection device of the present invention, in the architecture that a plurality of interconnection devices interconnect a lower level network and a high level network, the lower level protocol is operated via a virtual port and a virtual link, the higher level protocol preserves independently reliability of the virtual link, and by setting the state of the virtual port to the forwarding state, settings of blocking points of the lower level network by the lower level protocol are disposed on the lower level network side, i.e., at the lower level ports of the interconnection device or devices belonging to the lower level network. Accordingly, settings of blocking points by the lower level protocols can be prevented from being disposed on the core network side, i.e., at the higher level ports of the interconnection device or devices belonging to the higher level network, and it is possible to realize preventing a large loop of the whole network and loss of communication arrivability of the higher level network.

Since the lower level protocol is operated via the virtual port and virtual link, the higher level protocol can recover independently communications when a failure occurs in the higher level ports or higher level network, so that it is not necessary for the lower level protocol to switch a communication route to be caused by a failure in the higher level ports or higher level network. Accordingly, a stand-by operation for time-out of the timer is unnecessary for the lower level protocol operation in the architecture without direct connection between interconnection devices, and the communication route is switched by the lower level protocol only when a failure occurs in the lower level ports or lower level network, allowing high speed communication route switching by the lower level protocol.

Since the higher level protocol controls communication arrivability of the virtual link, the interconnection device may be disposed at any position of the higher level network and there is no restriction of the architecture regarding interconnection to the lower level network. Accordingly, the lower level network can be configured independently from the architecture of the higher level network and flexible network design is possible.

In the architecture wherein three or more interconnection devices interconnect a lower level network and a higher level network and the lower level protocol is used which requires that lines among devices are connected in one-to-one correspondence, each interconnection device has virtual ports corresponding in number to the number of other interconnection devices, virtual links are connected among the interconnection devices in one-to-one correspondence, and a communication route selection priority order of the virtual port is higher than that of the lower level ports, to allow settings of blocking points of the lower level network by the lower level protocol to be disposed on the lower level network side. Accordingly, it is possible to realize preventing a large loop of the whole network and loss of communication arrivability of the higher level network.

In the architecture wherein three or more interconnection devices interconnect a lower level network and a higher level network and the lower level protocol is used which requires that lines among devices are connected in one-to-one correspondence, the interconnection device may be disposed at any position of the higher level network and there is no restriction of the architecture regarding interconnection to the lower level network. Accordingly, the lower level network can be configured independently from the architecture of the higher level network and flexible network design is possible.

When a change of a communication route by the lower level protocol occurs, MAC address learning results are updated by using the MAC address learning clear packet to thereby prevent delay of communication route switching in the higher level network. Accordingly, it is possible to realize high speed communication route switching in the whole network.

In the method of processing the virtual port of the interconnection device, communication arrivability of the higher level network, i.e., virtual network, is confirmed by the health check packet, and if the health check packet does not arrive due to two or more failures in the high level ports or higher level network, the state of the virtual port is changed to the down-state so that the communication route can be switched by the lower level protocol. Accordingly, a communication route among interconnection devices via the lower level network can be established even when communications among the interconnection devices become impossible via the higher level network. Therefore, even if two or more failures occur in the higher level network, communications in the lower level network can be maintained. The health check packet time-out time is irrelevant to a timer to be used for control by the lower level protocol. It is obvious therefore that by shortening this time, it becomes possible to detect two or more failures in the higher level network without waiting for time-out by the lower level protocol. Accordingly, even for two or more failures in the higher level network, the lower level protocol can perform high speed communication route switching.

When the higher level ports or higher level network recovers from two or more failures, the higher level network is recovered after the higher level protocol confirms switching to the normal communication route by the lower level protocol, so that settings of blocking points of the lower level network to be caused by recovery of the higher level network can be made before recovery of data communications. Accordingly, it becomes possible to prevent a temporary loop of the whole network when recovering from two or more failures.

According to the other advantages of the present invention, in the case wherein the same protocol is used for both a higher level protocol and a lower level protocol and a large scale network is configured by using one redundancy protocol, the higher level network is divisionally connected to lower level networks by interconnection devices, to thereby realize localization of protocol processes regarding a communication route change. More specifically, a change in the communication route of the higher level network influences the lower level network not at all, and a change in a communication route in the lower level network results only in clearing the MAC address learning results in the lower level network and the connected higher level network. As a result, in changing the structure of the higher level network, an influence upon the lower level network is not required to be considered and the change can be performed easily. Further, even if a number of lower level networks are connected, a failure or a configuration change in some lower level network does not influence the other lower level networks so that stability of the networks can be improved. Furthermore, even if a lower level network is additionally connected, the influence range can be restricted only to clearing the MAC address learning results of the connected higher level network so that addition of the lower level network can be performed easily.

### BRIEF DESCRIPTION OF THE DRAWINGS

FIG. 1 is a diagram illustrating a method of relaying a control packet according to background art of the present invention.

FIG. 2 is a diagram illustrating a problem arising when a plurality of redundancy protocols are operated at one device at the same time, and an issue to be solved by the present invention.

FIG. 3 is a diagram showing the structure obtained by partitioning a network into a hierarchical structure according to the present invention.

FIG. 4 is a diagram illustrating interconnection using virtual ports and a virtual link between interconnection devices by a lower level protocol.

FIG. 5 is a diagram illustrating transmission/reception of a control packet of the lower level protocol via a virtual link.

FIG. 6 is a diagram showing three interconnection devices connected to networks.

FIG. 7 is a diagram illustrating a method of storing a lower network number and a virtual link number in a control packet.

FIG. 8 is a diagram showing the structure of an interconnection device.

FIG. 9 is a diagram showing a ring network and a spanning tree network connected together.

FIG. 10 is a diagram showing an example of a control packet of a spanning tree protocol to be transmitted via a virtual link.

FIG. 11 is a diagram illustrating a failure in a ring network in an architecture interconnecting the ring network and a spanning tree network.

FIG. 12 is a diagram illustrating a failure in a spanning tree network in an architecture interconnecting a ring network and the spanning tree network.

FIG. 13 is a diagram showing an architecture connecting two spanning networks to a ring network.

FIG. 14 is a diagram illustrating a failure in a spanning tree network in an architecture connecting two spanning networks to a ring network.

FIG. 15 is a diagram showing three interconnection devices for interconnecting a ring network and a spanning tree network.

FIG. 16 is a diagram showing an example of a control packet of a spanning tree protocol to be transmitted via a virtual link.

FIG. 17 is a diagram illustrating two failures in a ring network in an architecture interconnecting the ring network and a spanning tree network.

FIG. 18 is a diagram showing an architecture using a spanning tree protocol for both a higher level network and a lower level network.

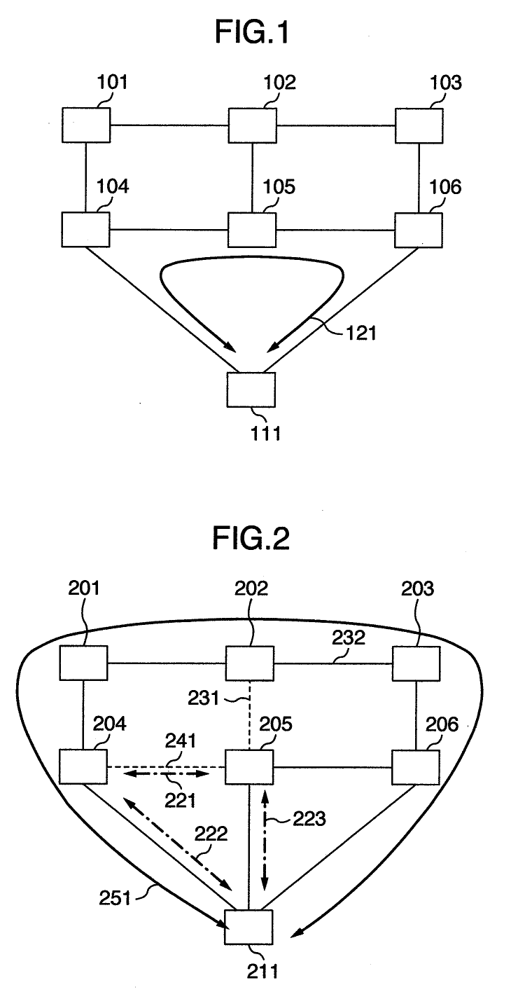

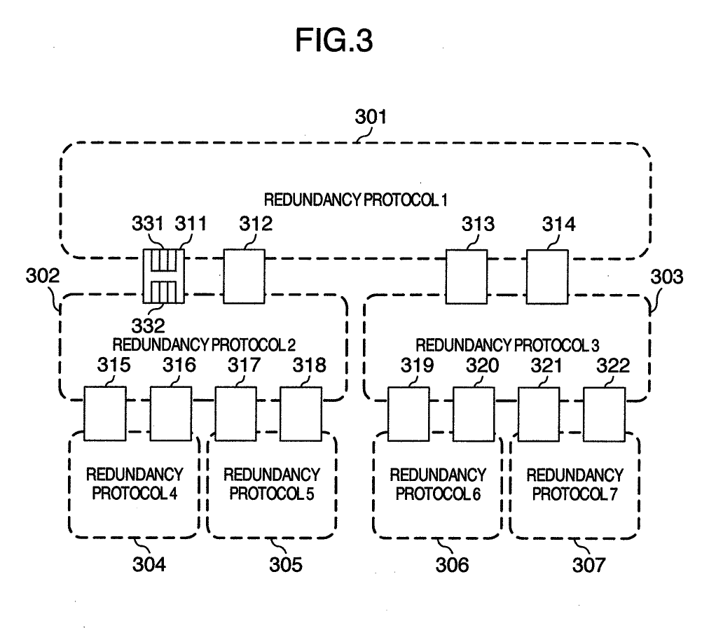

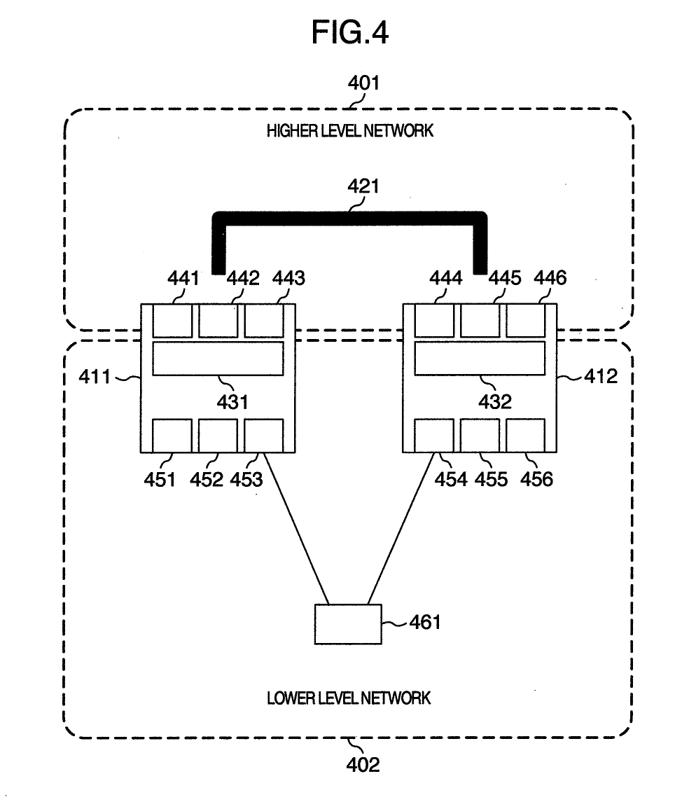

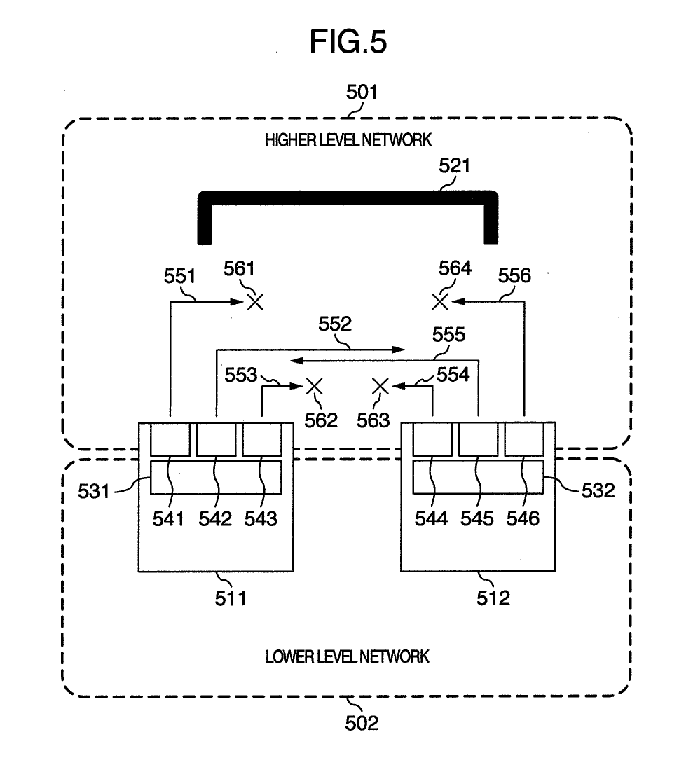

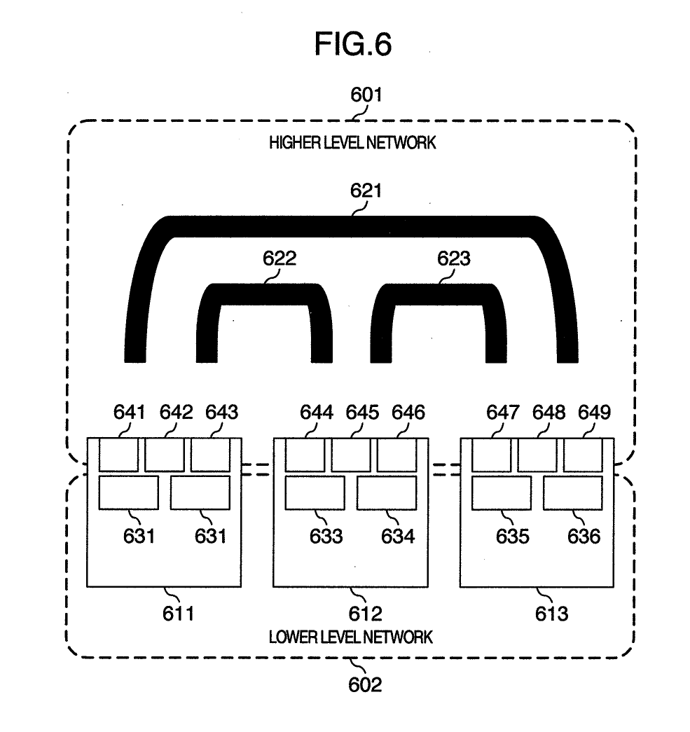

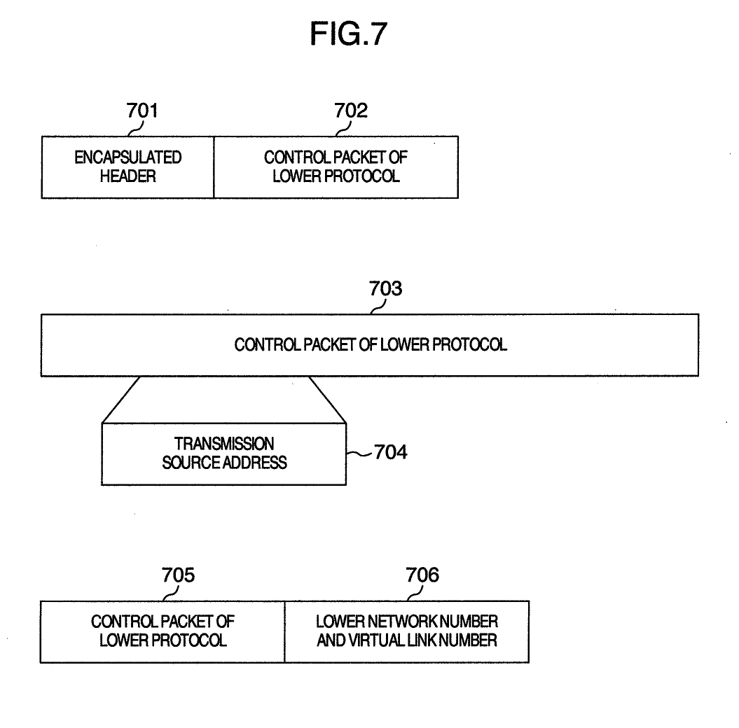

### DETAILED DESCRIPTION OF THE EMBODIMENTS

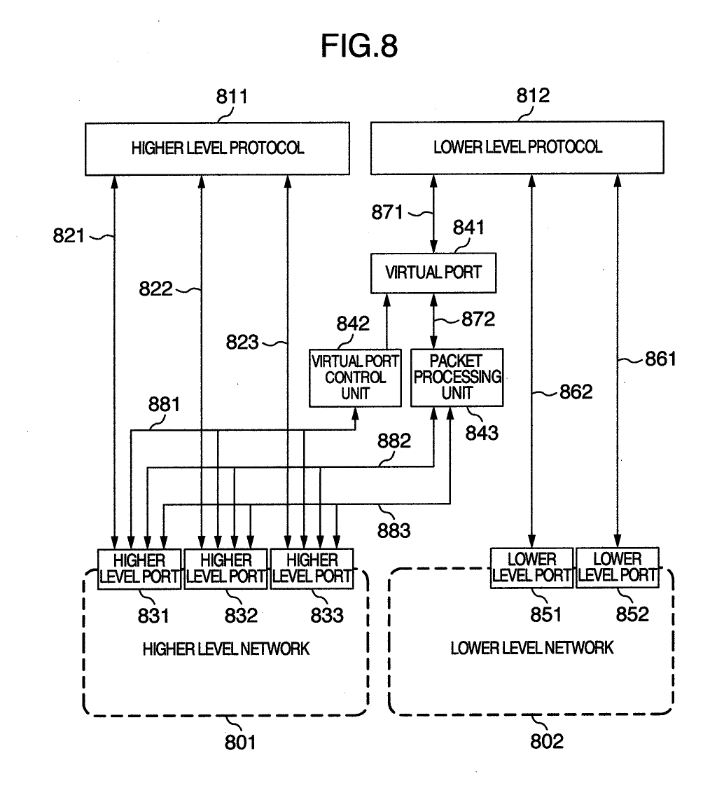

An embodiment of the present invention will be described with reference to FIG. 8. An interconnection device has higher level ports 831 to 833 for connection to a higher level network 801 and lower level ports 851 and 852 for connection to a lower level network 802. The numbers of higher level ports and lower level ports may be set as desired.

A higher level protocol 811 operates by using the higher level ports 831 to 833 as its control target. Control packets 821 to 823 of the higher level protocol are transmitted/received at the higher level ports to control a forwarding state and a blocking state representative of a logical communicable/incommunicable state of each higher level port. A blocking point by the higher level protocol is set to the higher level port of the interconnection device or to any one of devices and ports belonging to the higher level network. A data packet for transmission/reception and relay at the higher level ports by the interconnection device, a control packet for a virtual link by the lower level protocol, a MAC address learning clear packet and a health check packet are associated with only the port in the forwarding state among the forwarding state and blocking state determined for the higher level ports by the higher level protocol.

A lower level protocol 812 operates by using the lower level ports 851 and 852 and a virtual port 841 as its control target. Control packets 861 to 862 of the lower level protocol are transmitted/received at the lower level ports to control a forwarding state and a blocking state representative of a logical communicable/incommunicable state of each lower level port. A control packet 871 of the lower level protocol is transmitted/received at the virtual port. A blocking point by the lower level protocol is set to the lower level port of the interconnection device or to any one of devices and ports belonging to the lower level network. The virtual port is set either with a fixed forwarding state or with a blocking state. However, the blocking state of the virtual port is in a closed state only in the virtual port, and does not influence communications of the higher and lower level ports. A data packet for transmission/reception and relay at the lower level ports by the interconnection device is associated with only the port in the forwarding state among the forwarding state and blocking state determined for the lower level ports by the lower level protocol.

The interconnection device has a packet processing unit 843 for transmitting/receiving the control packet 882 of the lower level protocol and an MAC address learning clear packet 883 via the virtual port and virtual link. If a plurality of virtual ports are provided, the packet processing unit may be provided for each virtual port or may control a plurality of virtual ports.

The packet processing unit 843 transmits (882) a control packet 872 to be transmitted to the virtual port of the lower level protocol to all higher level ports 831 to 833. However, the control packet is transmitted only from the higher level port entered in the forwarding state by the higher level protocol.

A method of transmitting a control packet of the lower level protocol may selectively be a method of transmitting a control packet of the lower level protocol as it is without changing it, a method using a dedicated VLAN for transmission/reception of a control packet of the lower level protocol, and a method storing a lower level network number in a control packet.

If the interconnection device has a plurality of virtual ports, a method of transmitting a control packet of the lower level protocol may selectively be a method using a virtual link dedicated VLAN and a method storing a virtual link number in a control packet.

The method of transmitting a control packet of the lower level protocol can be used if the higher level protocol and lower level protocol are different protocols and if another lower level network using the same lower level protocol is connected to the same higher level network.

In the method using a dedicated VLAN for transmission/reception of a control packet of the lower level protocol, a lower level protocol dedicated VLAN is set to the higher level ports of the interconnection device and devices and ports belonging to the higher level network, and the packet processing unit transmits the control packet to be transmitted to the virtual ports by the lower level protocol, to the lower level protocol dedicated VLAN for all higher level ports, by adding VLAN TAG of the lower level protocol dedicated VLAN to the control packet. The control packet is transmitted only from the higher level port entered in the forwarding state by the higher level protocol.

If the interconnection device has a plurality of virtual ports and the method using the virtual link dedicated VLAN is selected for transmission of a control packet of the lower level protocol, a virtual link dedicated VLAN is set to the higher level ports of the interconnection device and devices and ports belonging to the higher level network, and the packet processing unit transmits the control packet to be transmitted to the virtual ports by the lower level protocol, to the virtual link dedicated VLAN for all higher level ports, by adding VLAN TAG of the virtual link dedicated VLAN to the control packet. The control packet is transmitted only from the higher level port entered in the forwarding state by the higher level protocol. If this method is used together with the method using the lower level protocol dedicated VLAN, the virtual link dedicated VLAN is used preferentially.

In the method storing the lower level network number in a control packet, the packet processing unit stores the lower level network number in the control panel to be transmitted to the virtual port by the lower level protocol, and transmits the control panel to all higher level ports. However, the control packet is transmitted only from the higher level port entered in the forwarding state by the higher level protocol.

If the interconnection device has a plurality of virtual ports and the method storing the virtual link number in a control packet of the lower level protocol for transmission of the control packet, the packet processing unit stores the virtual link number in the control panel to be transmitted to the virtual port by the lower level protocol, and transmits the control panel to all higher level ports. However, the control packet is transmitted only from the higher level port entered in the forwarding state by the higher level protocol.

As the method storing the lower network number and virtual link number in a control packet, a method storing the lower level network number and virtual link number in an added encapsulating header, in a transmission source MAC address field, or in a field added after the control packet, may be selected.

When the control packet of the lower level protocol arrives at any one of the higher level ports 831 to 833, the interconnection device receives the packet so long as the higher level is in the forwarding state entered by the higher level protocol.

If the method of transmitting the control packet of the lower level protocol is selected, upon reception of the control packet, the packet processing unit passes the control packet from the corresponding virtual port to the lower level protocol.

If the method using the lower protocol dedicated VLAN or virtual link dedicated VLAN is selected, upon reception of the control packet, the packet processing unit deletes VLAN TAG of the lower protocol dedicated VLAN or virtual link dedicated VLAN, and passes the packet from the corresponding virtual port to the lower level protocol.

If the method storing the lower level network number and virtual link number in the control packet is selected, the packet processing unit receives the arrived control packet if the lower level network number and virtual link number stored in the control packet are coincident with those of the interconnection device, judges which virtual port corresponds to the lower level network number and virtual link number stored in the control packet, deletes the lower level network number and virtual link number from the control packet, and passes the control packet from the corresponding virtual port to the lower level protocol. If the lower level network number and virtual link number stored in the control packet are not coincident with those of the interconnection device, the packet processing unit does not pass the control packet to the lower level protocol. In deleting the lower level network number and virtual link number, the encapsulating header is deleted if the method of storing the lower level network number and virtual link number in the added encapsulating header is selected, or deletes the field of the lower level network number and virtual link number if the method storing in the field after the control packet is selected.

The interconnection device received the control packet is processed by the packet processing unit and passed to the lower level protocol, can select whether the control packet is to be relayed to the higher level port other than the higher level port received the control protocol, entered in the forwarding state by the higher level protocol. If two interconnection devices are connected to the same lower level network, it is possible not to relay the control packet.

Of devices and ports belonging to the higher level network, a device other than the interconnection device connected to the lower level network relays the received control packet of the lower level protocol, in the higher level network. The control packet is relayed only to the port entered in the forwarding state by the higher level protocol. This control packet relay is similar to normal data relay and can be executed without modifying a conventional packet relay process.

The method of transmitting a control packet of the lower level protocol without changing the packet, in the transmission/reception process of the packet by the packet processing unit, has the merits that the packet processing unit is not required to change the packet and a packet relay process in the higher level network can be executed without modification, in the case wherein a higher level protocol and a lower level protocol are different and another lower level network using the same lower level protocol is not connected to the same higher level network.

The method of setting the lower level protocol dedicated VLAN and virtual link dedicated VLAN can be implemented easily because a conventional packet relay process can be applied to a relay and discrimination process for a control packet, particularly to a relay process at the device belonging to the higher level network other than the interconnection device and a relay process only for a higher level port of the interconnection device.

The method of storing a lower level network number and a virtual link number in a control packet has the merit that the number of used VLANs can be suppressed and special settings for each lower level network are not necessary in the device belonging to the higher level network other than the interconnection device.

One method of efficiently discriminating a control packet of the lower level protocol by the packet processing unit of a higher level network and an interconnection device is as follows. A lower level protocol dedicated VLAN is set to the whole higher level network, i.e., devices and ports belonging to the higher level network and higher level ports of the interconnection device, to make all lower level networks and all virtual links share the lower level protocol dedicated VLAN. A relay process only to a higher level port by the interconnection device is executed by a conventional packet relay process by the lower protocol dedicated VLAN, and whether the low level protocol receives the control packet is discriminated by storing a lower level protocol number and a virtual link number in the control packet. The device belonging to the higher level network other than the interconnection device executes a relay process for the packet in the lower level protocol dedicated VLAN without discriminating the content of the packet. Therefore, the packet relay process can be implemented easily while suppressing the number of VLANS and an amount of special settings.

In the method of storing a lower level network number and a virtual link number in a control packet of the lower level protocol, the method of using the above-described encapsulated header allows only a head portion of the packet to be referred, when the packet is for the virtual link, so that a packet can be judged easily at the device belonging to the higher level network and at the higher level ports of the interconnection device. It is therefore possible to suppress a device load of transmission, reception and relay of the packet in the higher level network. This method does not depend upon a protocol adopted as the lower level protocol and is applicable to all protocols.

The method using the field of the transmission source address stores a value directly in a portion of the control packet of the lower level protocol so that a length of the control packet is not necessary to be changed. It is therefore possible to adopt this method even if a maximum length of the packet has a limit. Many redundancy protocols do not refer to the transmission source address of the packet header so that this method can be used by many protocols.

The method adding a lower network number and a virtual link number after the packet stores the control packet itself at the top of the packet. It is therefore easy to judge whether the packet is a protocol packet when the higher level network performs special control such as preferential control for a control packet of the lower level protocol. Therefore, special control such as preferential control can be performed without changing settings and implementation of the packet relay method described in AX7800S/AX5400S Software Manual Applications Guide, Vol. 1, Ver. 10.2 compatible, ALAXALA Networks Corporation, June 2006, P. 190 and 191.

The packet processing unit 843 of the interconnection device has a function of updating MAC address learning results of the higher level network when a change in the communication route by the lower level protocol occurs. When a change in the communication route by the lower level protocol occurs, the lower level protocol notifies an update occurrence to the packet processing unit. The packet processing unit received the notice clears the MAC address learning results at the higher level ports of the interconnection device, and at the same time transmits (883) a MAC address learning clear packet to all higher level ports 831 and 833. The clear packet is not transmitted to the higher level port in the logically blocking state entered by the higher level protocol.

The MAC address learning clear packet may be any packet so long as it can be distinguished as the MAC address learning clear packet. For example, the packet can be distinguished by storing a special value in a transmission destination address field, a Ethernet (registered trademark) type field or another field.

The MAC address learning clear packet arrived at another interconnection device is received only if the arrived higher level port is in the forwarding state entered by the higher level protocol, and the packet processing unit clears the MAC address learning results at the higher level ports. At the same time, the MAC address learning clear packet is relayed to the higher level port in the forwarding state other than the higher level port received the MAC address learning clear packet. Even for the MAC address learning clear packet transmitted from an interconnection device of a different lower level network, the interconnection device connected to the same higher level network clears the MAC address learning results. The MAC address learning clear packet is processed by all interconnection devices connected to the higher level network. Even for the MAC address learning clear packet transmitted from an interconnection device of a different lower level network, the interconnection device connected to the same higher level network clears the MAC address learning results and relays the MAC address learning clear packet, in the higher level network.

Upon reception of the MAC address learning clear packet from the port in the forwarding state entered by the higher level protocol, a device and port belonging to the higher level network clear the MAC address learning results of the device, and relay the packet to another higher level port in the forwarding state entered by the higher level protocol.

A method of efficiently transmitting/receiving and relaying the MAC address learning clear packet is a method of transmitting/receiving and relaying the MAC address learning clear packet by using the above-described lower level protocol dedicated VLAN. The process of relaying the packet only to the higher level port by an interconnection device is executed by the lower level protocol dedicated VLAN by using a conventional packet relay process and the lower level protocol dedicated VLAN is shared for another use. It is therefore possible to facilitate implementation of a packet relay process while the number of used VLANs and the amount of special settings are suppressed.

The interconnection device has a virtual port control unit 842 for controlling the state of the virtual port 841. If the interconnection device has a plurality of virtual ports, the virtual port control unit may be provided for each virtual port, or one virtual port control unit may control a plurality of virtual ports. The virtual port control unit can selectively use a method fixing the state and a method controlling the state by the health check packet.

The method fixing the state by the virtual port control unit sets the virtual port always to the up-state. Under control of the virtual port control unit, the lower level protocol sets the virtual port always to the up-state, and processes the virtual port as having the highest priority degree of communication route selection to thereby fix the state of the virtual port to the forwarding state.

In the architecture having a plurality of virtual ports and forming a quasi network loop by a virtual link in one-to-one connection between interconnection devices and virtual links, the lower level protocol controls to set a blocking point to the virtual link in order to prevent a network loop by the virtual link to make the virtual link enter the blocking state. However, the blocking state of the virtual port is not applied to the corresponding higher level port and is made a quasi state. Controlling the higher level port by the higher level protocol and setting the blocking point to the higher level network correspond to prevention of a network loop by the virtual link and can obtain the same effects of preventing a network loop.

In the method that the virtual port control unit controls the state, the virtual port control unit has a timer for managing a health check packet time-out time for each virtual port.

The virtual port control unit transmits at a periodical interval the health check packet 881 to all higher level ports 831 to 833. The packet is transmitted only from the higher level port in the forwarding state entered by the higher level protocol.

The health check packet to be transmitted may be any packet so long as the packet can be discriminated as the health check packet. For example, the packet can be distinguished by storing a special value in a transmission destination address field, an Ethernet (registered trademark) type field or another field.

If the interconnection device has a plurality of virtual ports, a virtual link number is stored in the health check packet.

Upon arrival of the health check packet from any one of the higher level ports 831 to 833, the interconnection device receives the health check packet if only the higher level port is in the forwarding state entered by the higher level protocol. Upon reception of the health check packet, the virtual port control unit updates a timer managing the health check packet time-out time to return a lapse time to an initial value. If the interconnection device has a plurality of virtual ports, a virtual link number stored in the health check packet is referred to, the timer managing the health check packet time-out time is updated to return a lapse time to an initial value. By updating the timer, the virtual port control unit confirms communication arrivability of the virtual link, and preserves the up-state of the virtual port.

Not only the processing by the virtual port control unit, but also the interconnection device received the health check packet may relay the packet to the higher level port other than the received higher level port in the forwarding state entered by the higher level protocol.

Upon reception of the health check packet, a device belonging to the higher level network and connected to the lower level network relays the packet in the higher level network. Relaying the packet is performed only for the port in the forwarding state entered by the higher level protocol. This relay is preformed by a conventional packet relay process without any modification.

If the health check packet is not received during a predetermined time and the timer for the health check time-out time becomes a time-out, the virtual port control unit changes the state of the virtual port to the down-state, and notifies a change to the down-state to the lower level protocol. The lower level protocol detects a change to the down-state of the virtual port under its control and performs a protocol process to switch the communication route.

After the state of the virtual port is changed to the down-state, the virtual port control unit notifies suppression of switching a communication route to the higher level protocol. After reception of this notice, the higher level protocol notifies a switching processing state to the virtual port control unit when a state of switching processing of a communication route enters, and stands by until a response notice from the virtual port control unit before switching is actually performed. However, communications are switched only for the control packet of the lower level protocol, health check packet and MAC address learning clear packet which packets are transmitted via the virtual link. Upon reception of the switching processing notice from the higher level protocol, the virtual port control unit stands by during the health check packet time-out time before the health check packet is received. If the health check packet is received within the health check time-out time, the state of the virtual port is changed to the up-state and a change in the state of the virtual port is notified to the lower level protocol. The lower level protocol detects a change to the up-state of the virtual port under its control, and performs a protocol process to switch the communication route. The virtual port control unit stands by during a time required for the lower protocol to switch to a high speed communication route, and thereafter issues a response notice to the communication route switching processing notice, to the higher level protocol. Upon reception of the response notice, the higher level protocol switches data communications.

### First Embodiment

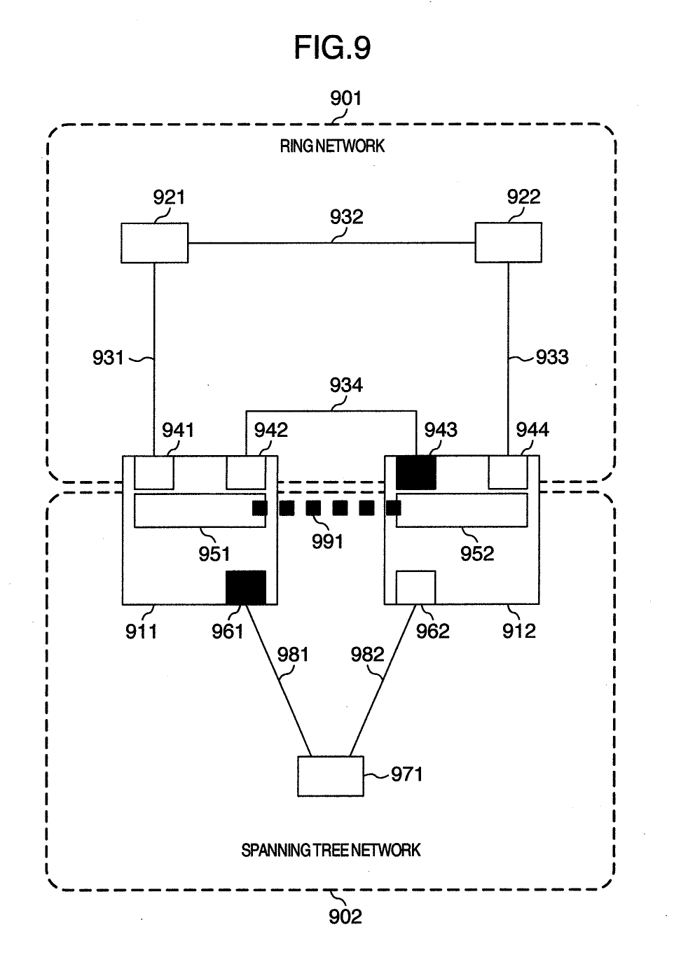

FIG. 9 shows an embodiment in which a ring network 901 as a higher level network under control of a ring protocol which is one of layer-2 redundancy protocols is connected to a spanning tree network 902 as a lower level network under control of a spanning tree protocol which is one of layer-2 redundancy protocols. The ring network as the higher level network is connected to the spanning tree network as the lower level network by interconnection devices 911 and 912. The spanning tree network is redundancy-connected to the ring network via two interconnection devices.

The ring network 901 constitutes a ring topology by devices 911, 912, 921 and 922 and lines 931 to 934. The ring protocol operates as the higher level protocol on the devices 921 and 922, and also on the interconnection devices 911 and 912 to control higher level ports 941 to 943. The ports under control transmit/receive the control packet of the ring protocol. Under control of the ring protocol, a blocking point is set to the higher level port 943 of the interconnection device 912. The higher level port 943 is in the logically blocking state and operates as the port for shutting off communications.

The spanning tree network 902 constitutes a triangle topology by devices 911, 912 and 971, lines 981 and 982 and a virtual link 991 for logically connecting a virtual port 951 of the interconnection device 911 and a virtual port 952 of the interconnection device 912. The spanning tree protocol operates as the lower level protocol on the device 971, and also on the interconnection devices 911 and 912 to control lower level ports 961 and 962. The spanning tree protocol operates on the virtual ports 951 and 952 via the virtual link 991. The ports under control transmit/receive the control packet of the spanning tree protocol. Under control of the spanning tree protocol, a blocking point is set to the lower level port 961 of the interconnection device 911. The lower level port 961 is in the logically blocking state and operates as the port for shutting off communications.

The spanning tree protocol at the interconnection device 911 transmits the control packet of the spanning tree protocol to the higher level ports 941 and 942 via the virtual port 951, and the packet arrives at the higher level port 944 of the interconnection device 912, and received at the virtual port 951 of the interconnection device 911 by the spanning tree protocol.

The spanning tree protocol at the interconnection device 912 transmits the control packet of the spanning tree protocol to the higher level ports 943 and 944 via the virtual port 952, actually only to the higher level port 944 because the higher level port 943 is in the blocking state entered by the ring protocol. The packet arrives at the higher level port 941 of the interconnection device 911, and received at the virtual port 951 of the interconnection device 911 by the spanning tree protocol.

The states of the virtual ports 951 and 952 of the interconnection devices 911 and 912 are fixed to the up-state, and the spanning tree protocol controls the virtual ports to have the highest priority degree of communication route selection to set the blocking point to the lower level port.

In the architecture shown in FIG. 9, a lower level protocol dedicated VLAN is set for transmission/reception of the control packet of the spanning tree protocol and MAC address learning clear packet via the virtual link 991. The lower level protocol dedicated VLAN includes the higher level ports 941 and 942 of the interconnection device 911, the higher level ports 943 and 944 of the interconnection device 912, ports for connecting the lines 931 and 932 of the device 921 and ports for connecting the lines 932 and 933 of the device 922.

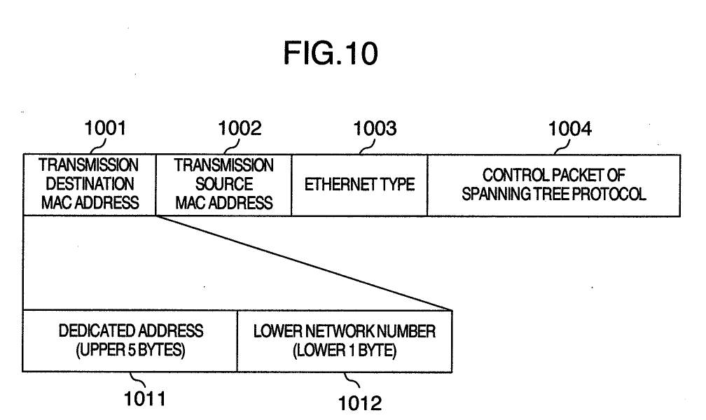

FIG. 10 shows an example of the format of the control packet of the spanning tree protocol to be transmitted via the virtual link 991. The control packet 1004 transmitted to the virtual port by the spanning tree protocol at the interconnection devices 911 and 912 is encapsulated with a transmission destination MAC address 1001, a transmission source MAC address 1002 and an Ethernet (registered trademark) type 1003. The transmission destination MAC address contains a specific address of upper five bytes and a lower level network number in a lower one byte. The interconnection device identifies that the packet is the control packet of the spanning tree protocol by the lower level network, from the specific address of the upper bytes of the transmission destination MAC address or Ethernet (registered trademark) type, and identifies the lower level network number from the lower one byte of the transmission destination MAC address.

As the spanning tree control protocol transmits the control packet to the virtual ports 951 and 952, the interconnection devices 911 and 912 perform the above-described encapsulation, store the lower level network number in the lower one byte of the transmission destination MAC address, and transmit the control packet to the higher level port. The interconnection device at the transmission destination received the packet identifies the lower level network number from the lower one byte of the transmission destination MAC address, deletes the encapsulated transmission destination MAC address, transmission source MAC address and Ethernet (registered trademark) type, and makes the spanning tree protocol receive the control packet of the spanning tree protocol from the virtual port.

In the communication routes in the normal state shown in FIG. 9, a loop of the whole network is prevented and communication arrivability is preserved for all devices in the whole network.

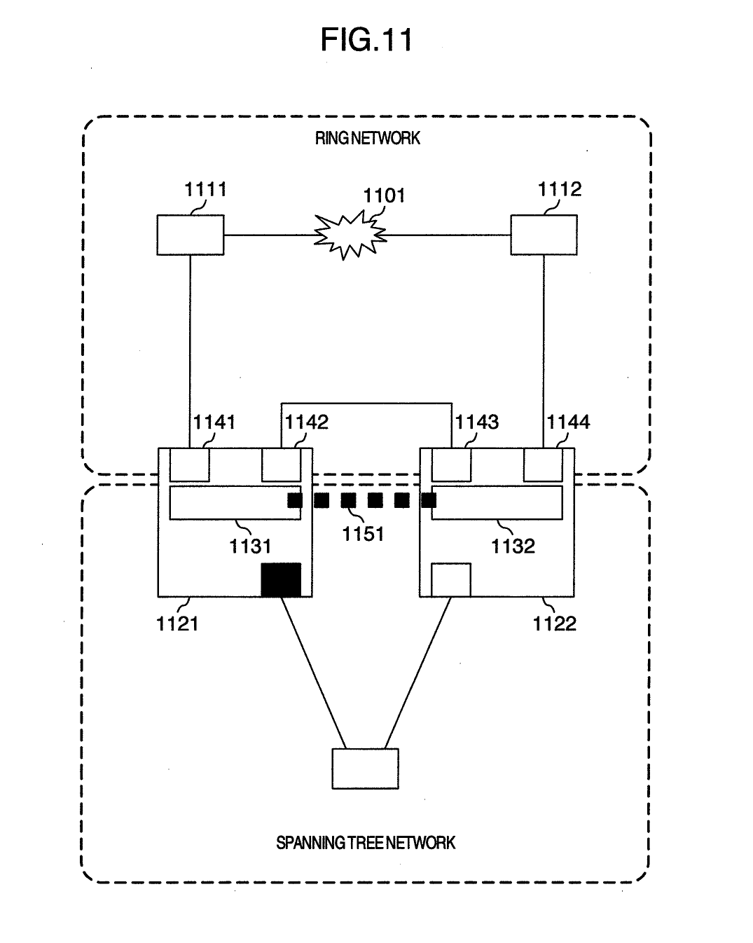

FIG. 11 illustrates an example that a failure occurs in the ring network as the higher level network in the architecture shown in FIG. 9. In this example, a line failure 1101 occurs in the ring network, and a communication route via the line connecting devices 1111 and 1112 in the ring network is broken. In this case, under control of the ring protocol, the state of a higher level port 1143 of the interconnection device 1122 changes to the forwarding state.

In transmitting the control packet via the virtual port 1131 and virtual link 1151, the spanning tree protocol at the interconnection device 1121 transmits the control packet to the higher level ports 1141 and 1142 in the same manner as that in the normal state shown in FIG. 9. The interconnection device 1122 receives the control packet transmitted from the interconnection device 1121 to the virtual port 1131 at the higher level port 1143, because of a change in the communication route by the ring protocol.

Similarly, the control protocol transmitted by the spanning tree protocol at the interconnection device 1122 to the virtual port 1132 arrives at the higher level port 1142 of the interconnection device 1121.

In this manner, since the ring protocol switches the communication route upon failure in the ring network, the control packet by the spanning tree protocol arrives via the virtual port and virtual link without any interception. A failure in the ring network will not influence the outside of the ring network.

Even if a failure in the ring network occurs not only at the position shown in FIG. 11, but also at the higher level port of the interconnection device or at another device or line in the ring network, communication arrivability of the virtual link can be preserved in the similar manner under control of the ring protocol, and a failure will not influence the outside of the ring network. This is also true for recovery from a failure.

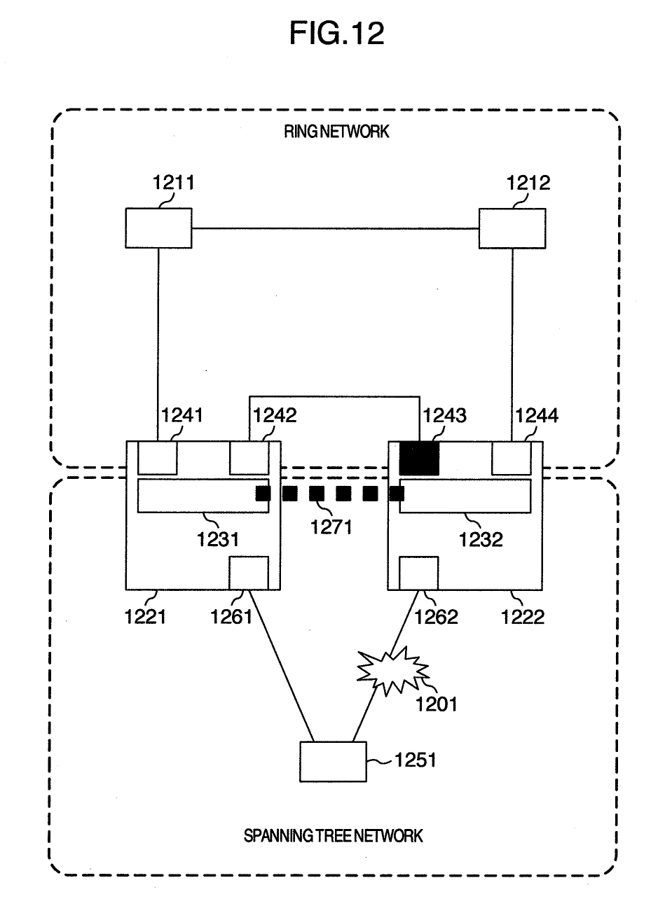

FIG. 12 illustrates an example that a failure occurs in the spanning tree network as the lower level network in the architecture shown in FIG. 9. In this example, a line failure 1201 occurs in the spanning tree network, and a communication route via the line connecting a device 1251 and a lower level port 1262 of an interconnection device 1222 in the spanning tree network is broken. In this case, under control of the spanning tree protocol, the state of a lower level port 1261 of an interconnection device 1221 changes to the forwarding state.

In this case, a protocol process by the ring protocol will not occur, and transmission/reception of the control panel of the spanning tree protocol via a virtual link 1271 is maintained.

Upon detection of a communication route change in the spanning tree network, the interconnection device 1221 transmits a MAC address learning clear packet to higher level ports 1241 and 1242. The MAC address learning clear port transmitted from the higher level port 1241 arrives at a higher level port 1244 of the interconnection device 1222 via devices 1211 and 1212. Upon reception of the packet, the devices 1211 and 1212 clear MAC address learning results, and also relay the packet. Upon reception of the packet, the interconnection device 1222 clears MAC address learning results of the higher level ports 1244 and 1243, and the higher level port 1243 does not relay the packet because of its blocking state. With these operations, all MAC address learning results in the ring network are cleared when the communication route of the spanning tree network is changed, and communications over the whole network are recovered at high speed.

### Second Embodiment

The second embodiment shows a case wherein two or more lower level networks are connected to one higher level network.

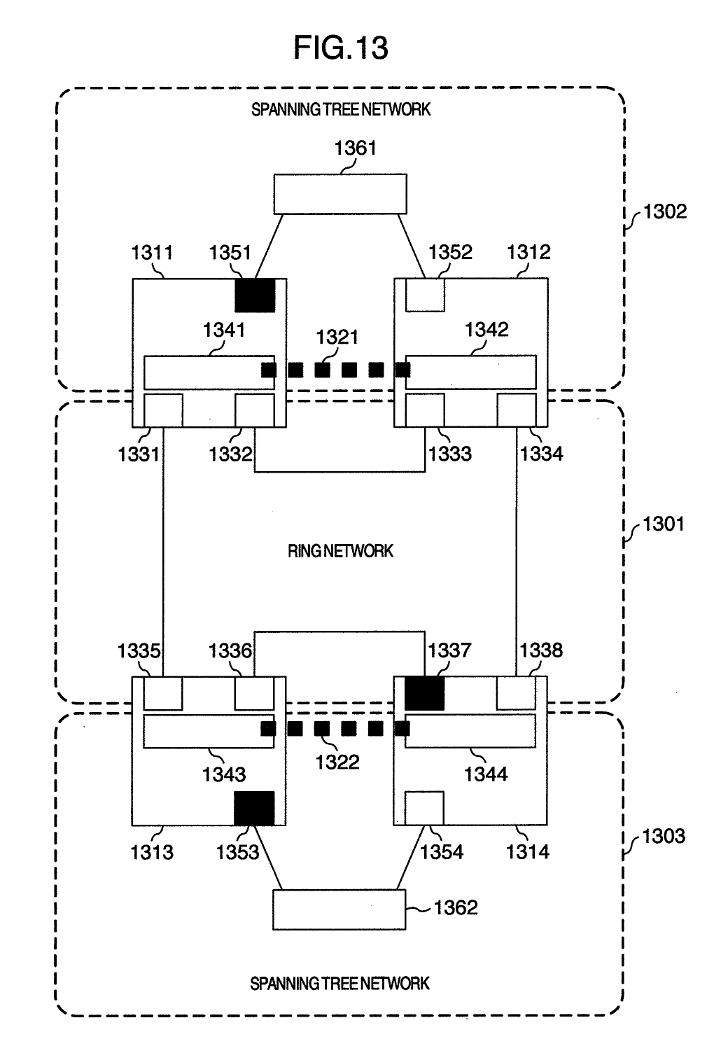

FIG. 13 shows an example adding one spanning tree network as the lower level network to the architecture of the first embodiment shown in FIG. 9. Spanning tree networks 1302 and 1303 as the lower level network are connected to a ring network 1301 as the higher level network. The spanning tree network 1302 is connected to the ring network 1301 by interconnection devices 1311 and 1312, whereas the spanning tree network 1303 is connected to the ring network 1301 by interconnection devices 1313 and 1314. The ring network is constituted of higher level ports 1331 and 1332 of the interconnection device 1311, higher level ports 1333 and 1334 of the interconnection device 1312, higher level ports 1335 and 1336 of the interconnection device 1313, and higher level ports 1337 and 1338 of the interconnection device 1314. Under control of the ring protocol, a blocking point is set to the higher level port 1337. Spanning tree protocols of the spanning tree networks 1302 and 1303 control virtual links 1321 and 1322 connected between virtual ports 1341 and 1342 and between virtual ports 1343 and 1344, and lower level ports 1351, 1352, 1353 and 1354 of the interconnection devices. A blocking point is set to the lower level port 1351 of the interconnection device 1311 of the spanning tree network 1302, and to the lower level port 1353 of the interconnection device 1313 of the spanning tree network 1303.

A lower level network number of the spanning tree network 1302 is represented by “1”, and that of the spanning tree network 1303 is represented by “2”.

The interconnection devices 1311 and 1312 of the spanning tree network 1302 transmit/receive a control packet via the virtual ports 1341 and 1342 and the virtual link 1321, by storing the lower level network number “1” in the control packet. The interconnection devices 1311 and 1312 transmit/receive the control packet storing the lower level network number “1”. The interconnection devices 1311 and 1312 do not transmit/receive a control packet storing a different lower level network number, e.g., the control packet storing the lower level network number “2” of the lower level spanning tree network, and only relay it to the higher level port. Similarly, the interconnection devices 1313 and 1314 transmit/receive only the control packet storing the lower level network number “2”, and only relay a control packet storing a different lower level network number to the higher level port.

Similar to the first embodiment, a failure in the ring network does not influence the spanning tree networks 1302 and 1303 as the lower level network.

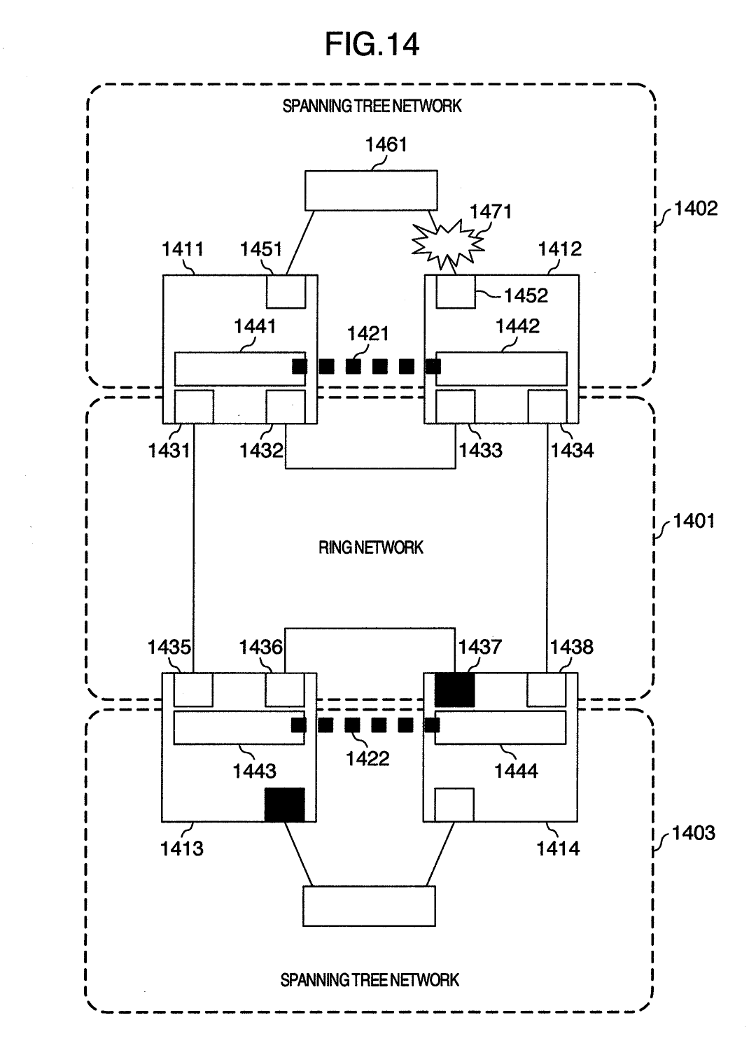

FIG. 14 illustrates an example that a failure occurs in one spanning tree network as the lower level network in the architecture shown in FIG. 13. In this example, a line failure 1471 occurs in a spanning tree network 1402, and a communication route via the line connecting a device 1461 and a lower level port 1452 of an interconnection device 1412 in the spanning tree network is broken. In this case, under control of the spanning tree protocol, the state of a lower level port 1451 of an interconnection device 1411 changes to the forwarding state.

In this case, a protocol process by the ring protocol will not occur. In a spanning tree network 1403, since interconnection devices 1413 and 1414 will not receive a control packet having the lower level network number “1” and transmission/reception of a control packet of the spanning tree protocol via virtual ports 1443 and 1444 and a virtual link 1422 is maintained, and protocol process by the spanning tree will not occur in the spanning tree network 1403. Transmission/reception of a control packet of the spanning tree protocol via virtual ports 1441 and 1442 and a virtual link 1421 is also maintained.

Upon detection of a communication route change in the spanning tree network, the interconnection device 1411 transmits a MAC address learning clear packet to higher level ports 1431 and 1432. The MAC address learning clear packet transmitted from the higher level port 1431 arrives at a higher level port 1435 of the interconnection device 1413. Upon reception of the packet, the interconnection device 1413 clears MAC address learning results regarding the higher level ports 1435 and 1436, and also relays the packet to another higher level port 1436 in the forwarding state. Although the relayed packet arrives at a higher level port 1437 of the interconnection device 1414, the higher level port 1437 neither receives nor relays because of its blocking state. Similarly, the MAC address learning clear packet transmitted from the higher level port 1432 of the interconnection device 1411 arrives at a higher level port 1433 of the interconnection device 1412, and the interconnection device 1412 clears MAC address learning results regarding higher level ports 1433 and 1434, and also relays the packet to another higher level port 1434. The interconnection device 1414 receives the packet at its higher level port 1438, and clears the MAC address learning results regarding the higher level ports 1437 and 1438. Since the higher level port 1437 is in the blocking state, the packet is not relayed at this port. With these operations, all MAC address learning results in the ring network are cleared when the communication route of the spanning tree network 1402 is changed, and communications over the whole network are recovered at high speed.

A failure influence range including clearing the MAC address learning results is only in the spanning tree network 1402 and ring network, and the other spanning tree network 1403 as the lower level network will be influenced not at all. This means that a failure in one lower level network will not influence other lower level networks and a failure influence range is localized.

The operations of the invention are obviously similar even if the interconnection devices are set to any positions of the ring network in FIG. 13. For example, the operations are similar even if the positions of the interconnection devices 1311 and 1313 are exchanged or even if a device of a ring network is added between the interconnection devices. This means that the set positions of the interconnection devices are not restricted and a flexible network can be configured.

### Third Embodiment

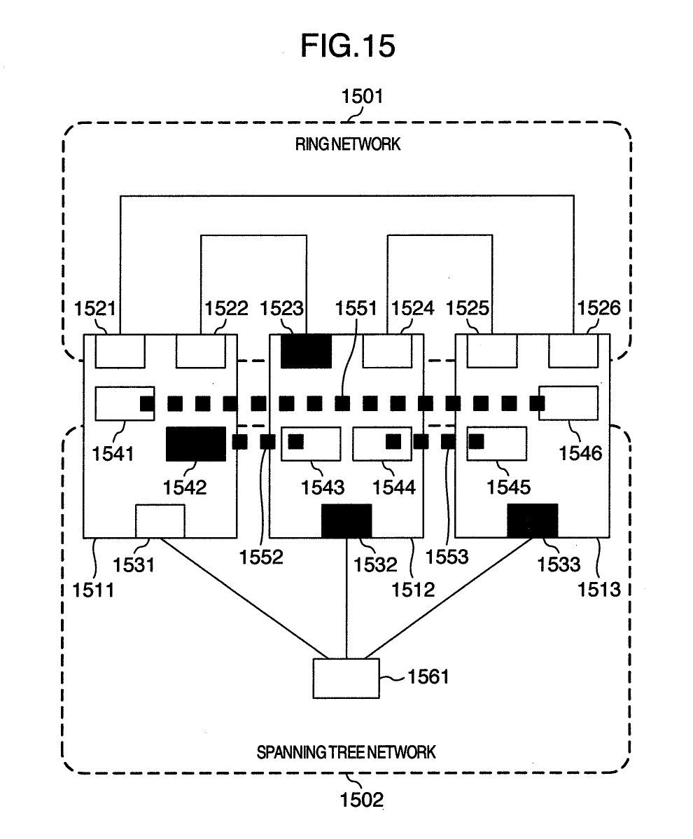

FIG. 15 shows an architecture in which three interconnection devices 1511 to 1513 are connected to a ring network 1501 as the higher level network, and three types of redundancy communication routes are prepared for a spanning tree network 1502 as the lower level network. The spanning tree protocol requires direct connections between ports in order to realize high speed switching. Therefore, two virtual ports are prepared for each interconnection device, interconnection devices 1511 and 1513 are connected by a virtual link 1551 via virtual ports 1541 and 1546, the interconnection devices 1511 and 1512 are connected by a virtual link 1552 via virtual ports 1542 and 1543, and the interconnection devices 1512 and 1513 are connected by a virtual link 1553 via virtual orts 1544 and 1545. Communications among the virtual links are made redundant by the ring network.

Under control of the ring protocol, a blocking point is set to a higher level port 1523 of the interconnection device 1512 in the ring network 1501.

In the spanning tree network 1502, the virtual ports have the highest priority degree of communication route selection. Under control of the spanning tree protocol, a blocking point is set to a lower level port 1532 of the interconnection device 1512 and a lower level port 1533 of the interconnection device 1513. Then, the virtual ports are prevented from being the blocking state. Under control of the spanning tree protocol, the virtual port 1542 is entered in the blocking state in order to prevent a network loop by the virtual link. However, the blocking state of the virtual port is a pseudo state and is not applied to the higher level ports and lower level ports corresponding to the virtual port.

The interconnection devices 1511 to 1513 transmit a control packet of the spanning tree protocol to virtual links corresponding to respective virtual ports. The control packet to be transmitted uses a lower level protocol dedicated VLAN including higher level ports 1521 to 1526 of the interconnection devices 1511 to 1513.

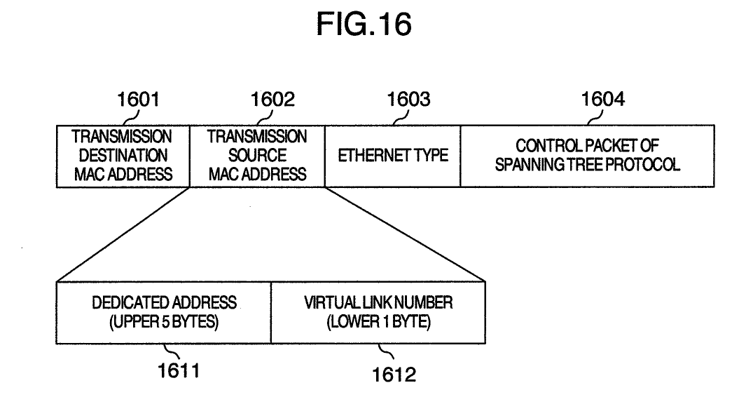

FIG. 16 shows an example of the format of the control packet of the spanning tree protocol to be transmitted via the virtual links 1551 to 1553. The control packet 1604 transmitted to the virtual ports by the spanning tree protocol at the interconnection devices 1511 to 1513 is encapsulated with a transmission destination MAC address 1601, a transmission source MAC address 1602 and an Ethernet (registered trademark) type 1603. The transmission destination MAC address contains a specific address of upper five bytes and a virtual link number in a lower one byte. The interconnection device identifies that the packet is the control packet of the spanning tree protocol by the lower level network, from the transmission destination address or the Ethernet type, and identifies the virtual link number from the lower one byte of the transmission source MAC address.

Description will be made on transmission/reception of a control packet by the virtual link 1551, by representing a virtual link number of the virtual link 1551 by “1”, a virtual link number of the virtual link 1552 by “2” and a virtual link number of the virtual link 1553 by “3”. As the spanning tree control protocol transmits the control packet to the virtual ports 1541 and 1546, the interconnection devices 1511 and 1513 perform the above-described encapsulation, stores the virtual link number “1 in the lower one byte of the transmission MAC address, and transmits the control packet to the higher level port. The interconnection device at the transmission destination receives the packet identifies the virtual link number “1” from the lower one byte of the transmission source MAC address, deletes the encapsulated transmission destination MAC address, transmission source MAC address and Ethernet (registered trademark) type, and makes the spanning tree receive the control packet of the spanning tree protocol from the virtual ports 1541 and 1546. As the encapsulated control packet arrives at the higher level port 1524 of the interconnection device 1512 via the virtual link having the virtual link number “1”, the interconnection device does not receive the control packet because the virtual link number does not correspond to the virtual ports of the interconnection device, and relays it to the higher level port if it exists in the forwarding state. In the example shown in FIG. 15, relay is not performed because the higher level port 1523 is in the blocking state.

In the architecture shown in FIG. 15, the operations similar to the first and second embodiments are performed when a failure occurs in the ring network or spanning tree network or if a plurality of networks as the lower level network of the spanning tree protocol are connected to the ring network as the higher level network.

### Fourth Embodiment

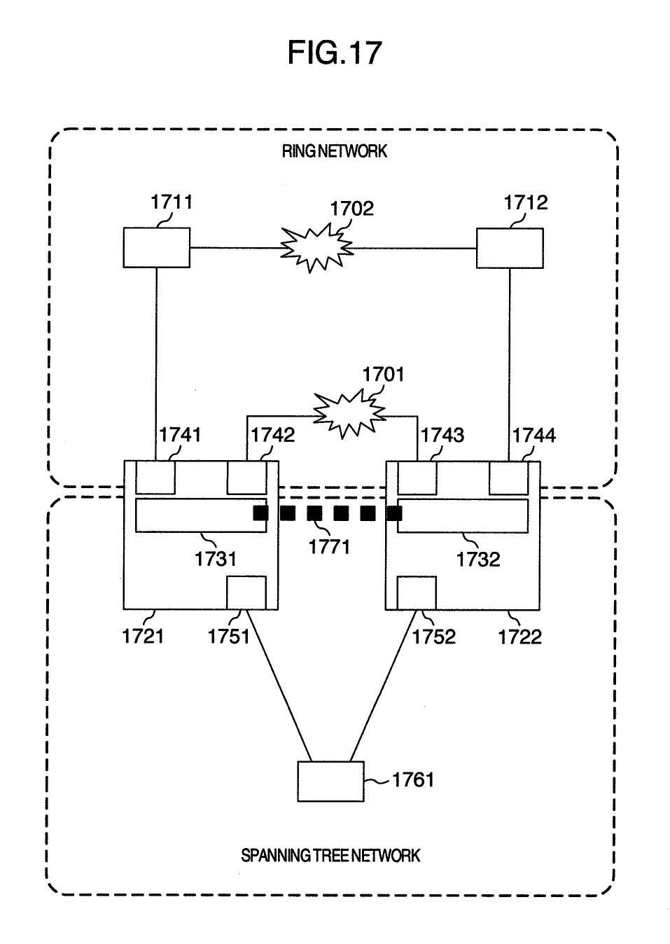

This embodiment shows an example that communication arrivability of the virtual link is monitored by the health check packet of the first embodiment, and double failures occur in the ring network as the higher level network. FIG. 17 shows an example that double failures occur in the ring network in the architecture shown in FIG. 9.

An interconnection device 1721 shown in FIG. 17 monitors communication arrivability of a virtual link 1771 connected via a virtual port 1731 to a virtual port 1732 of an interconnection device 1722, by a health check packet. Similarly, the interconnection device 1722 monitors communication arrivability of the virtual link 1771 by a health check packet. The interconnection device 1721 transmits at a periodical interval the health check packet to all higher level ports 1741 and 1742 in the forwarding state, and the health check packet is received via the ring network by the interconnection device 1722. In the state shown in FIG. 9 before a failure occurs, the blocking point is set to a higher level port 1743 of the interconnection device 1722, and the interconnection device 1722 receives the health check packet from a higher level port 1744. The interconnection devices 1721 and 1722 each have a timer for managing a health check packet time-out time regarding the virtual ports 1731 and 1732. The timer is updated to an initial value each time the health check packet is received. While the health check packet is received within the timer-out time, the interconnection devices 1721 and 1722 maintain the virtual ports 1731 and 1732 in the up-state.

Devices 1711 and 1712 belonging to the ring network perform only relay of a health check packet in the ring network. This relay is performed only for the port entered in the forward state by the ring protocol. At the same time when the packet is received, the interconnection devices 1721 and 1722 perform relay of the packet only to the higher level port entered in the forwarding state by the ring protocol. The packet arrived from the higher level port in the blocking state is neither received nor relayed.

As line failures 1701 and 1702 occur in the ring network, a state enters losing an arrival communication route to the virtual link 1771. As time-out occurs not receiving the health check packet within the health check packet time-out time, the interconnection device 1721 changes the state of the virtual port 1731 to the down-state, and notifies a change to the down-state to the spanning tree protocol. Upon reception of the notice of a change to the down-state, the spanning tree protocol changes a communication route to set the forwarding state to all of a lower level port 1751 of the interconnection device 1721, a lower level port 1752 of the interconnection device 1722 and ports of a device 1761 belonging to the spanning tree network. With this switching of the communication route, communications between the interconnection devices 1721 and 1722 can be continued by the lower level ports 1751 and 1752 and the device 1761 even during double failures in the ring network so that communication arrivability in the spanning tree network can be preserved. When a communication route is changed by the spanning tree protocol, a MAC address learning clear packet is transmitted from the higher ports to clear the MAC address learning results in the ring network, and communication arrivability is preserved only at a site where an arrivable communication route exists in the ring network.

When any one of the line failures 1701 and 1702 in the ring network is recovered, a communication route is reconfigured in the ring network to recover communication variability of the virtual link 1771. The interconnection devices 1721 and 1722 continue to try transmission of the health check packet even in the down-state, and when the health check packet regarding the virtual ports 1731 and 1732 is received, changes the states of the virtual ports 1731 and 1732 to the up-state, and notifies a change to the spanning tree protocol. Upon reception of a notice of a change to the up-state, the spanning tree protocol changes a communication route, selecting the virtual ports 1731 and 1732 as the communication route with priority over other routes, and sets a blocking point to any one of the lower level ports 1751 and 1752 and the device 1761. In the state shown in FIG. 9, a blocking state is set to the lower level port 1751 of the interconnection device 1721. In this manner, as the ring network is recovered, the spanning tree protocol returns to a normal state communication route. Also in this case, a MAC address learning clear packet is transmitted from the higher level ports to clear the MAC address learning results in the ring network and recover communications of the whole network at high speed.

As the line failures 1701 and 1702 occur in the ring network and the arrival communication route for the virtual link 1771 is lost, the interconnection devices change the states of the virtual ports 1731 and 1732 to the down-state. At this time, the interconnection devices 1721 and 1722 start suppressing switching of a communication route by the ring protocol. When any one of the line failures 1701 and 1702 recovers and a state switching a communication route enters, communications via the virtual link 1771 are first recovered for the control packet, MAC address learning clear packet and health check packet by the spanning tree. Thereafter, the interconnection devices 1721 and 1722 transmit the health check packet. As the health check packet is received within the health check packet time-out time after receiving the packet, the states of the virtual ports 1731 and 1732 are changed to the up-state, and the communication route of the spanning tree is changed. The ring protocol stands by during a time required for high speed switching of the communication route of the spanning tree, e.g., about two seconds, after entering the state for switching the communication route, and thereafter switches and recovers all communication routes. In this manner, when recovering from double failures in the ring network, first a blocking point is set to the spanning tree network through a communication route change in the spanning tree, and then communications of the ring network are recovered to thereby prevent a temporary loop in the whole network.

When any one of the line failures 1701 and 1702 is recovered and a state switching a communication route enters, communications via the virtual link 1771 are first recovered for the control packet, MAC address learning clear packet and health check packet by the spanning tree. This means that communications only by the lower level protocol dedicated VLAN are recovered first.

### Fifth Embodiment

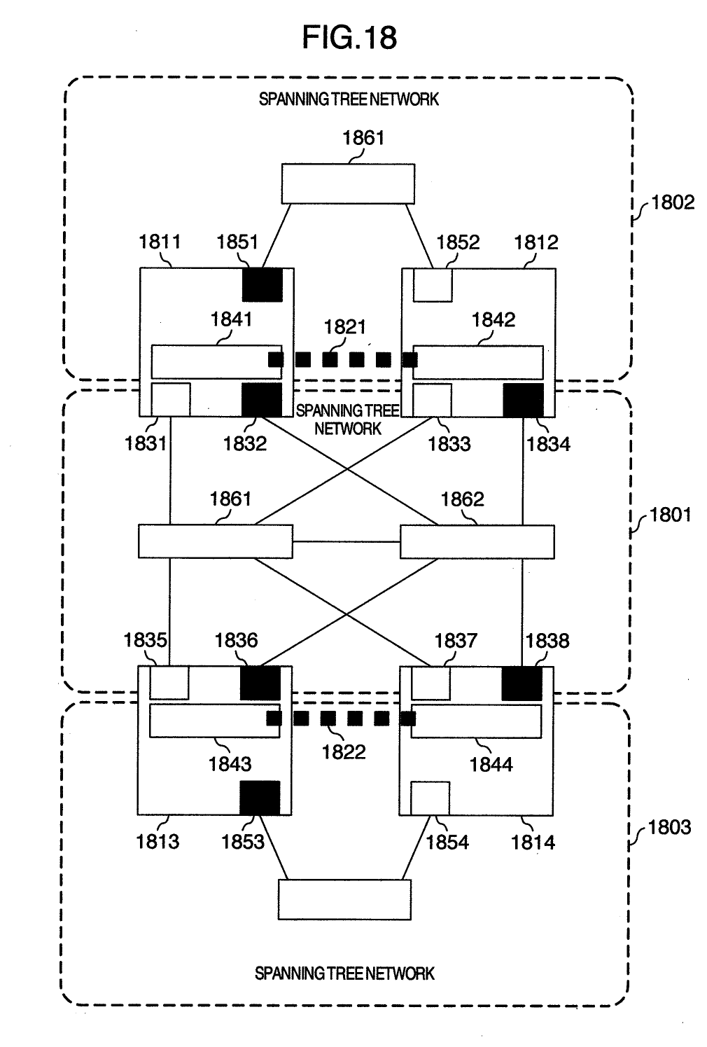

FIG. 18 shows an example in which a spanning tree protocol is used for both the lower level and high level networks. Spanning tree networks 1802 and 1803 as the lower level network are connected to a spanning tree network 1801 as the higher level network. The spanning tree network 1802 is connected to the spanning tree network 1801 as the higher level network by interconnection devices 1811 and 1812. The spanning tree network 1803 is connected to the spanning tree network 1801 as the higher level network by interconnection devices 1813 and 1814. The spanning tree network 1801 is constituted of higher level ports 1831 and 1832 of the interconnection device 1811, higher level ports 1833 and 1834 of the interconnection device 1812, higher level ports 1835 and 1836 of the interconnection device 1813, high level ports 1837 and 1838 of the interconnection device 1814, and devices 1861 and 1862 belonging to the spanning tree network 1801. Under control of the spanning tree protocol, a blocking point is set to the higher level ports 1832, 1834, 1836 and 1838. In the spanning tree networks 1802 and 1803, the spanning tree protocol controls virtual links 1821 and 1822 via virtual ports 1841 to 1844, and lower level ports 1851 to 1854 of the interconnection devices. A blocking point is set to the lower level port 1851 of the interconnection device in the spanning tree network 1802 and the lower level port 1853 of the interconnection device in the spanning tree network 1803.

A lower level network number of the spanning tree network 1802 is represented by “1”, and the lower level network of the spanning tree network 1803 is represented by “2”.

In the architecture shown in FIG. 18, the operations are similar to those of the second embodiment, excepting only that the higher level protocol for controlling the higher level network is changed from the ring protocol to the spanning tree protocol and that the spanning tree network 1801 as the higher level network has the structure suitable for the spanning tree protocol. When control packets of the spanning tree networks 1802 and 1803 are transmitted/received via the virtual links 1821 and 1822, the control packets are transmitted/received by storing corresponding lower level network numbers. The interconnection devices 1811 and 1812 receive only the control packet storing the lower level network number “1”, and the interconnection devices 1813 and 1814 receive only the control packet storing the lower level network number “2”. A change in the communication route due to a failure in the spanning tree network 1801 as the higher level network is confined in the spanning tree network 1801 and does not influence the lower level networks. For a change in the communication route due to a failure in the spanning tree networks 1802 and 1803 as the lower level network, the communication route of the spanning tree network 1802 or 1803 with a failure is changed and the MAC address learning results in the spanning tree network 1801 as the higher level network and at the higher ports of the interconnection devices 1811 to 1814 are cleared, and the other lower level network without a failure is not influenced.

With the arrangement described above, an influence range of a network architecture change and a failure can be localized in the case wherein a network is required to be configured by using one protocol or an already existing network is reused.

It should be further understood by those skilled in the art that although the foregoing description has been made on embodiments of the invention, the invention is not limited thereto and various changes and modifications may be made without departing from the spirit of the invention and the scope of the appended claims.

1. A device for interconnecting a higher level network using a redundancy protocol providing communication routes with redundancy and a lower level network using a redundancy protocol same as or different from the redundancy protocol of said higher level network, the device comprising:
higher level ports for connection to said higher level network; and
lower level ports for connection to said lower level network,
wherein:
the redundancy protocol of said higher level network operating at the device controls only said higher level ports, and the redundancy protocol of said lower level network operating at the device collects all said higher level ports to recognize all said higher level ports as a virtual port, and controls said virtual port and said lower level ports; and
the device and another device interconnecting said higher level network and said lower level network are connected via said virtual port by a virtual link using a route of said higher level network, and the redundancy protocol of said lower level network is operated via said virtual port and said virtual link to make the redundancy protocol of said higher level network establish the connection of said virtual link and to make said lower level network be redundancy-connected to said higher level network.

2. The device according to claim 1, wherein a control packet to be transmitted to said virtual port by the redundancy protocol of said lower level network is transmitted to said higher level ports in accordance with a communicable/incommunicable state of said higher level ports under control of the redundancy protocol of said higher level network, and the redundancy protocol of said lower level network receives said control packet from said virtual port in accordance with the communicable/incommunicable state of said higher level ports under control of the redundancy protocol of said higher level network.

3. The device according to claim 1, wherein a state of said virtual port possessed by the redundancy protocol of said lower level network is always set to an up-state, and the redundancy protocol of said lower level network controls said virtual port as a highest priority port, in selecting a communication route.

4. The device according to claim 2, wherein said control packet of the redundancy protocol of said lower level network received from said virtual port is relayed to a higher level port other than the higher port received said control packet in accordance with the communicable/incommunicable state of said higher level port under control of the redundancy protocol of said higher level network.

5. The device according to claim 4, wherein whether said control packet of the redundancy protocol of said lower level network received from said virtual port is relayed or not can be selected.

6. The device according to claim 1, wherein:
said higher level network and said lower level network are interconnected by the device and a plurality of other devices; and
the device is connected to said plurality of other devices via a plurality of virtual ports by a plurality of virtual links using routes of said higher level network, in one-to-one correspondence.

7. The device according to claim 2, wherein the redundancy protocol of said lower level network transmits said control packet to said virtual port, and in judging said control packet received from said higher level port, judges the packet as said control packet received from said virtual port if the device receives a packet coincident with said control packet of the lower network by said redundancy protocol.

8. The device according to claim 2, further comprising a virtual LAN (VLAN) dedicated to said control packet of said lower level network by said redundancy protocol, wherein when said control packet is to be transmitted to said higher level port via said virtual port, said redundancy protocol of said lower level network transmits said control packet to said dedicated VLAN, and in judging a packet received from said higher level port, judges the packet as a packet received from said virtual port if said packet is received from said dedicated VLAN.

9. The device according to claim 2, wherein in transmitting said control packet, said redundancy protocol of said lower level network transmits said control packet by storing a lower level network number for identifying said lower level network in said control packet, and in judging a packet received from said higher level port, judges from said lower level network number stored in said control packet that the received packet is a packet received from said virtual port.

10. The device according to claim 2, further comprising a dedicated VLAN in one-to-one correspondence with said virtual link, wherein in transmitting said control packet to said higher level port via said virtual port, said redundancy protocol of said lower level network transmits said control packet to said dedicated VLAN, and in judging a packet received from said higher level port, judges from said dedicated VLAN that said packet was received at which virtual port.

11. The device according to claim 2, wherein in transmitting said control packet, said redundancy protocol of said lower level network transmits said control packet by storing a virtual link number for identifying said virtual link in said control packet, and in judging a packet received from said higher level port, judges from said virtual link number stored in said control packet that said packet was received at which virtual port.

12. The device according to claim 1, wherein:
said higher level network is also connected to other lower level networks different from said lower level network; and
the device further comprises a dedicated VLAN provided for said lower level network and for each of said other lower level networks, in transmitting said control packet to said higher level port via said virtual port, said redundancy protocol of said lower level network transmits said control packet to said dedicated VLAN of said lower level network belonging to the device, and in judging a packet received from said higher level port, judges that said packet is a packet received from said virtual port if said packet is received from said dedicated VLAN of said lower level network belonging to the device, whereas if said packet is received from said dedicated VLAN different from said dedicated VLAN belonging to the device, does not receive but relays said packet.

13. The device according to claim 1, wherein:
said higher level network is also connected to other lower level networks different from said lower level network; and
in transmitting said control packet, said redundancy protocol of said lower network transmits said control packet by storing a lower level network number for identifying each of said other lower level networks in said control packet, and in judging a packet received from said higher level port, judges that said packet is a packet received from said virtual port if said lower level network number stored in said control packet is said lower level network number of said lower level network belonging to the device, whereas if said lower level network number is said lower level network number different from said lower level network number of said lower level network different from said lower level network belonging to the device, does not receive but relays said packet.

14. The device according to claim 1, wherein when a change in a communication route occurs by said redundancy protocol of said lower level network, a MAC address learning clear packet is transmitted from said higher level port, and when said MAC address learning clear packet is received from said higher level port, MAC address learning results at said higher level ports are cleared.

15. The device according to claim 14, wherein said MAC address learning clear packet is transmitted to said higher level port in accordance with a communicable/incommunicable state of said higher level port to be controlled by said redundancy protocol of said higher level network, and received in accordance with a communicable/incommunicable state of said higher level port to be controlled by said redundancy protocol of said higher level network.

16. The device according to claim 2, wherein a health check packet is transmitted/received at a periodical interval to/from said virtual link via said higher level port to confirm communication arrivability of said virtual link, a state of said virtual port is set to an up-state while said communication arrivability is confirmed, and if said health check packet is not received in a predetermined time, the state of said virtual port is changed to a down-state and a communication route of said lower level network is changed by said redundancy protocol.

17. The device according to claim 16, wherein if said health check packet is received after the state of said virtual port is changed to the down-state, the state of said virtual port is changed to the up-state and a communication route of said lower level network is changed by said redundancy protocol.

18. The device according to claim 16, wherein when said higher level network is recovered by said redundancy protocol of said higher level network after the state of said virtual port is changed to the down-state, said redundancy protocol of said higher level network recovers communications of only said control packet, said health check packet and said MAC address clear packet respectively be said redundancy protocol of said lower level network via said virtual link, after the recovery, the state of said virtual port is changed to the up-state, a communication route is changed by the redundancy protocol of said lower level network, and thereafter data communications are recovered by said redundancy protocol of said higher level network.
